(19) United States
(12) Patent Application Publication
(10) Pub. No.: US 2024/0031540 A1
(43) Pub. Date: Jan. 25, 2024

(54) FOVEATED DOWN SAMPLING OF IMAGE DATA

(71) Applicant: Apple Inc., Cupertino, CA (US)

(72) Inventors: Chihsin Wu, San Jose, CA (US); David R. Pope, Campbell, CA (US); Sheng Lin, San Jose, CA (US); Amnon D. Silverstein, Cupertino, CA (US)

(21) Appl. No.: 17/870,456

(22) Filed: Jul. 21, 2022

(51) Int. Cl. H04N 9/64; G06T 3/40

(52) U.S. Cl. CPC H04N 9/64; G06T 3/40

(57) ABSTRACT

A foveated down sampling (FDS) circuit for down sampling of pixels in images. The FDS circuit down samples a first subset of pixels of a same color in an image using first scaling factors to generate first down sampled pixels in a first down sampled version of the image. The FDS circuit further down samples a second subset of the first down sampled pixels of the same color using second scaling factors to generate second down sampled pixels of the same color in a second down sampled version of the image. Pixels from the first subset are arranged in a first direction, and pixels from the second subset are arranged in a second direction.

### BACKGROUND

### 1. Field of the Disclosure

The present disclosure relates to a circuit for processing image data, and more specifically to a circuit for foveated down sampling of image data.

### 2. Description of the Related Arts

Image data captured by an image sensor or received from other data sources is often processed in an image processing pipeline before further processing or consumption. For example, raw image data may be corrected, filtered, or otherwise modified before being provided to subsequent components such as a video encoder. To perform corrections or enhancements for captured image data, various components, unit stages or modules may be employed.

Such an image processing pipeline may be structured so that corrections or enhancements to the captured image data can be performed in an expedient way without consuming other system resources. Although many image processing algorithms may be performed by executing software programs on central processing unit (CPU), execution of such programs on the CPU would consume significant bandwidth of the CPU and other peripheral resources as well as increase power consumption. Hence, image processing pipelines are often implemented as a hardware component separate from the CPU and dedicated to performing one or more image processing algorithms.

However, image processing pipelines do not account for the use of a wide-angle lens (e.g., a fisheye lens) to generate the image data. When a wide-angle lens is used to generate the image data, the refraction angle of light with different wavelength varies thereby manifesting itself on the image sensor as shifted focal points that are not aligned among red, green, and blue color channels. Thus, color fringing is present at sharp and high contrast edges of full-color images generated from the image data.

### SUMMARY

Embodiments relate to an image processor that includes a foveated down sampling and correction circuit for correcting chromatic aberrations in images captured by one or more image sensors coupled to the image processor. The foveated down sampling and correction circuit includes a first correction circuit (e.g., a vertical foveated down sampling and correction circuit) and a second correction circuit (e.g., a horizontal correction circuit) coupled to the first correction circuit. The first correction circuit performs down sampling and interpolation of pixel values of a first subset of pixels of a same color in a raw image using first down sampling scaling factors and first interpolation coefficients to generate first corrected pixel values for pixels of the same color in a first corrected version of the raw image. The pixels in the first subset are arranged in a first direction (e.g., vertical direction), the first down sampling scaling factors gradually vary along the first direction, and the first interpolation coefficients correspond to first offset values. The first offset values represent first distances from each down sampling pixel location along the first direction to corresponding first virtual pixels in the first direction.

The second correction circuit receives the first corrected pixel values of the first corrected version and performs interpolation of pixel values of a second subset of the pixels in the first corrected version using second interpolation coefficients to generate second corrected pixel values for pixels of the same color in a second corrected version of the raw image. The pixels in the second subset are arranged in a second direction (e.g., horizontal direction) perpendicular to the first direction, and the second interpolation coefficients correspond to second offset values. The second offset values represent second distances from the second subset of pixels to corresponding second virtual pixels in the second direction.

In some embodiments, the image processor further includes a down sampling circuit coupled to the second correction circuit. The down sampling circuit receives the second corrected pixel values for pixels of the same color in the second corrected version. The down sampling circuit performs down sampling of a subset of the pixels of the same color of the second corrected version using second down sampling scaling factors to generate corrected pixel values for pixels of the same color in a corrected version of the raw image. The pixels in the subset are arranged in the second direction, and the second down sampling scaling factors gradually vary along the second direction.

Embodiments of the present disclosure further relate to a foveated down sampling circuit in an image processor for performing foveated down sampling of pixels in captured images. The foveated down sampling circuit includes a first down sampling circuit and a second down sampling circuit coupled to the first down sampling circuit. The first down sampling circuit down samples a first subset of pixels of a same color in a raw image using first scaling factors to generate first down sampled pixels of the same color in a first down sampled version of the image, the first subset of pixels arranged in a first direction. The second down sampling circuit receives a second subset of the first down sampled pixels arranged in a second direction. The second down sampling circuit then down samples the second subset of pixels of the same color using second scaling factors to generate second down sampled pixels of the same color in a second down sampled version of the raw image.

### BRIEF DESCRIPTION OF THE DRAWINGS

Figure (FIG. 1 is a high-level diagram of an electronic device, according to one embodiment.

FIG. 2 is a block diagram illustrating components in the electronic device, according to one embodiment.

FIG. 3A is a first block diagram illustrating image processing pipelines implemented using an image signal processor, according to one embodiment.

FIG. 3B is a second block diagram illustrating image processing pipelines implemented using an image signal processor, according to one embodiment.

FIG. 3C is a second block diagram illustrating image processing pipelines implemented using an image signal processor, according to one embodiment.

FIG. 4A is an example vertical foveated down sampling of an image, according to one embodiment.

FIG. 4B is an example horizontal foveated down sampling of an image, according to one embodiment.

FIG. 5A is a conceptual diagram illustrating longitudinal/axial chromatic aberration, according to one embodiment.

FIG. 5B is a conceptual diagram illustrating lateral/transverse chromatic aberration, according to one embodiment.

FIG. 5C is a conceptual diagram illustrating raw image data generated by an image sensor using a wide-angle lens, according to one embodiment.

FIG. 6 is a block diagram illustrating a detailed view of a foveated down sampling and correction circuit, according to one embodiment.

FIG. 7A is a conceptual diagram illustrating a combined vertical foveated down sampling and interpolation of the raw image data, according to one embodiment.

FIG. 7B is a conceptual diagram illustrating a horizontal interpolation of the raw image data, according to one embodiment, according to one embodiment.

FIG. 8 is a diagram illustrating pixel neighbors of a given pixel, according to one embodiment.

FIG. 9A is a block diagram illustrating a detailed view of an example foveated down sampling circuit, according to one embodiment.

FIG. 9B is a block diagram illustrating a detailed view of another example foveated down sampling circuit, according to one embodiment.

FIG. 10A is a block diagram of an example raw processing stage with a foveated down sampling circuit, according to one embodiment.

FIG. 10B is a block diagram of another example raw processing stage with a foveated down sampling circuit, according to one embodiment.

FIG. 10C is a block diagram of an example resample processing stage with a foveated down sampling circuit, according to one embodiment.

FIG. 11 is a flowchart illustrating a method of performing foveated down sampling and correction to reduce color fringing of the raw image data, according to one embodiment.

FIG. 12 is a flowchart illustrating a method of performing foveated down sampling, according to one embodiment.

The figures depict, and the detail description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to a foveated down sampling and correction circuit in an image processor for correcting chromatic aberrations in captured images generated by one or more image sensors coupled to the image processor. The foveated down sampling and correction circuit includes a vertical foveated down sampling and correction circuit as well as a horizontal correction circuit coupled to an output of the vertical foveated down sampling and correction circuit. The vertical foveated down sampling and correction circuit performs the combined foveated down sampling and chromatic aberration recovery in the vertical direction of a raw image generated by the one or more image sensors. The vertical foveated down sampling and correction circuit generate first corrected pixel values for pixels of a same color in a first corrected version of the raw image. The horizontal correction circuit receives the first corrected pixel values from the vertical foveated down sampling and correction circuit, and performs chromatic aberration recovery in the horizontal direction of the first corrected version of the raw image. The horizontal correction circuit generates second corrected pixel values for pixels of the same color in a second corrected version of the raw image with chromatic aberrations reduced in comparison with the raw image.

Embodiments of the present disclosure further relate to foveated down sampling circuit in the image processor where an image may be divided into two general portions—a foveated (or central) portion corresponding to a foveated (or central) field-of-view, and a peripheral portion corresponding a peripheral field-of-view. Since the peripheral field-of-view is typically less important, the peripheral portion of the image can be down sampled into a lower resolution for simpler processing. On the other hand, the foveated (or central) portion of the image may be either down sampled but having a higher resolution than the peripheral portion of the image, or not be down sampled to preserve its original resolution.

A circuit presented herein for the foveated down sampling includes a first down sampling circuit (e.g., a vertical foveated down sampling circuit or horizontal foveated down sampling circuit) and a second down sampling circuit (e.g., a horizontal foveated down sampling circuit or vertical foveated down sampling circuit) coupled to the first down sampling circuit. The first down sampling circuit performs, in a streaming manner, foveated down sampling of a first subset of pixels of a same color in an image (e.g., raw image) using first scaling factors to generate first down sampled pixels of the same color in a first down sampled version of the image, the first subset of pixels arranged in a first direction (e.g., vertical direction or horizontal direction). The second down sampling circuit receives, in the streaming manner, a second subset of the first down sampled pixels arranged in a second direction (e.g., horizontal direction or vertical direction). The second down sampling circuit then performs, in the streaming manner, foveated down sampling of the second subset of pixels of the same color using second scaling factors to generate second down sampled pixels of the same color in a second down sampled version of the image. In accordance with this approach, pixels incoming into the foveated down sampling circuit may be processed in a single pass through columns and rows of the image.

### Exemplary Electronic Device

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with Figure (FIG. 1 (e.g., device 100) may include a touch-sensitive surface for receiving user input. The electronic device may also include one or more other physical user-interface devices, such as a physical keyboard, a mouse and/or a joystick.

Figure (FIG. 1 is a high-level diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, head set jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors that may be used for face recognition. Additionally or alternatively, image sensors 164 may be associated with different lens configuration. For example, device 100 may include rear image sensors, one with a wide-angle lens and another with as a telephoto lens. Device 100 may include components not shown in FIG. 1 such as an ambient light sensor, a dot projector and a flood illuminator.

Device 100 is only one example of an electronic device, and device 100 may have more or fewer components than listed above, some of which may be combined into a component or have a different configuration or arrangement. The various components of device 100 listed above are embodied in hardware, software, firmware or a combination thereof, including one or more signal processing and/or application specific integrated circuits (ASICs). While the components in FIG. 1 are shown as generally located on the same side as the touch screen 150, one or more components may also be located on an opposite side of device 100. For example, the front side of device 100 may include an infrared image sensor 164 for face recognition and another image sensor 164 as the front camera of device 100. The back side of device 100 may also include additional two image sensors 164 as the rear cameras of device 100.

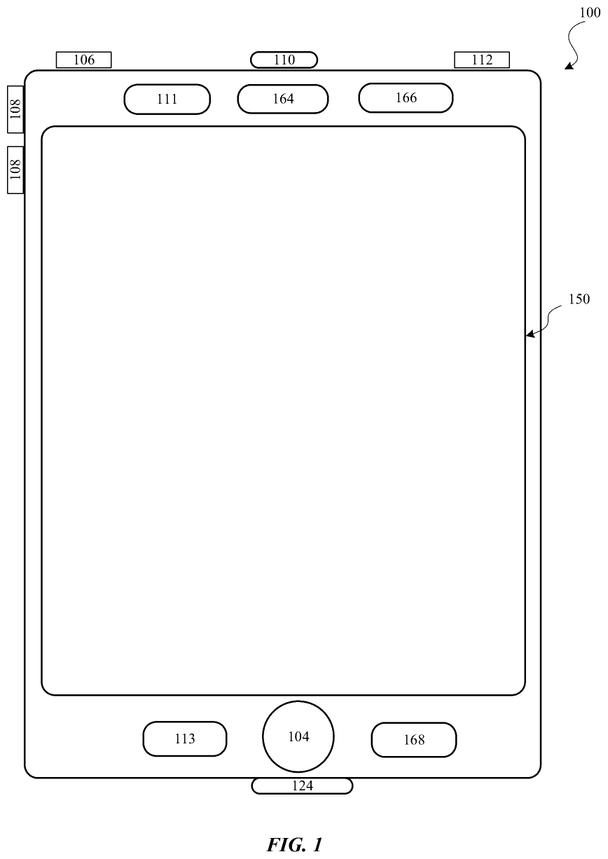

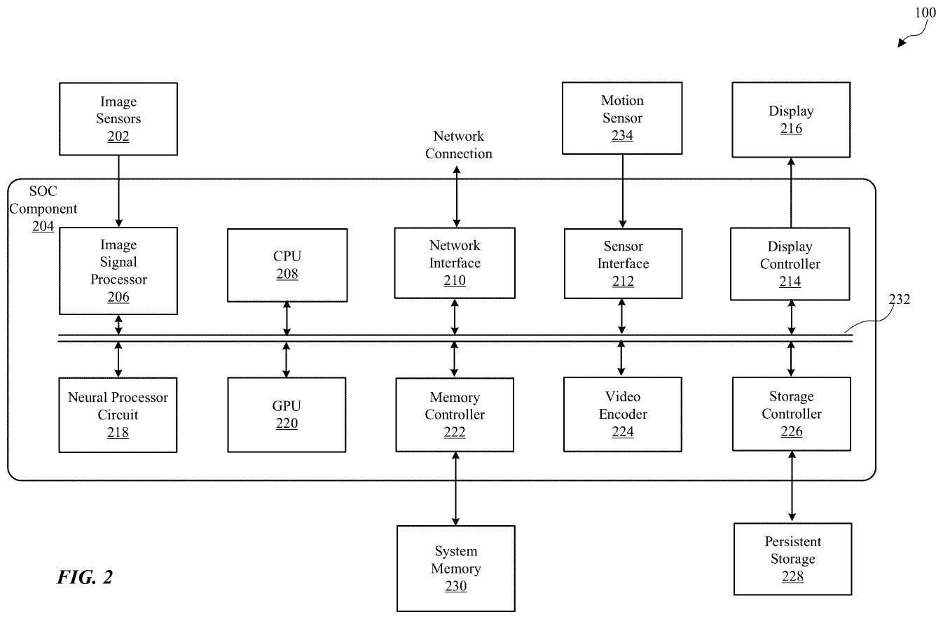

FIG. 2 is a block diagram illustrating components in device 100, according to one embodiment. Device 100 may perform various operations including image processing. For this and other purposes, the device 100 may include, among other components, image sensors 202, system-on-a chip (SOC) component 204, system memory 230, persistent storage (e.g., flash memory) 228, motion sensor 234, and display 216. The components as illustrated in FIG. 2 are merely illustrative. For example, device 100 may include other components (such as speaker or microphone) that are not illustrated in FIG. 2. Further, some components (such as motion sensor 234) may be omitted from device 100.

Image sensors 202 are components for capturing image data. Each of image sensors 202 may be embodied, for example, as a complementary metal-oxide-semiconductor (CMOS) active-pixel sensor, a camera, video camera, or other devices. Image sensors 202 generate raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensors 202 may be in a Bayer color filter array (CFA) pattern (hereinafter also referred to as “Bayer pattern”). Image sensor 202 may also include optical and mechanical components that assist image sensing components (e.g., pixels) to capture images. The optical and mechanical components may include an aperture, a lens system, and an actuator that controls the focal length of image sensor 202.

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, a liquid crystal display (LCD) device or an organic light emitting diode (OLED) device. Based on data received from SOC component 204, display 216 may display various images, such as menus, selected operating parameters, images captured by image sensors 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. In some embodiments, system memory 230 may store pixel data or other image data or statistics in various formats.

Persistent storage 228 is a component for storing data in a non-volatile manner. Persistent storage 228 retains data even when power is not available. Persistent storage 228 may be embodied as read-only memory (ROM), flash memory or other non-volatile random access memory devices.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, motion sensor interface 212, display controller 214, graphics processor unit (GPU) 220, memory controller 222, video encoder 224, storage controller 226, and various other input/output (I/O) interfaces 218, and bus 232 connecting these subcomponents. SOC component 204 may include more or fewer subcomponents than those shown in FIG. 2.

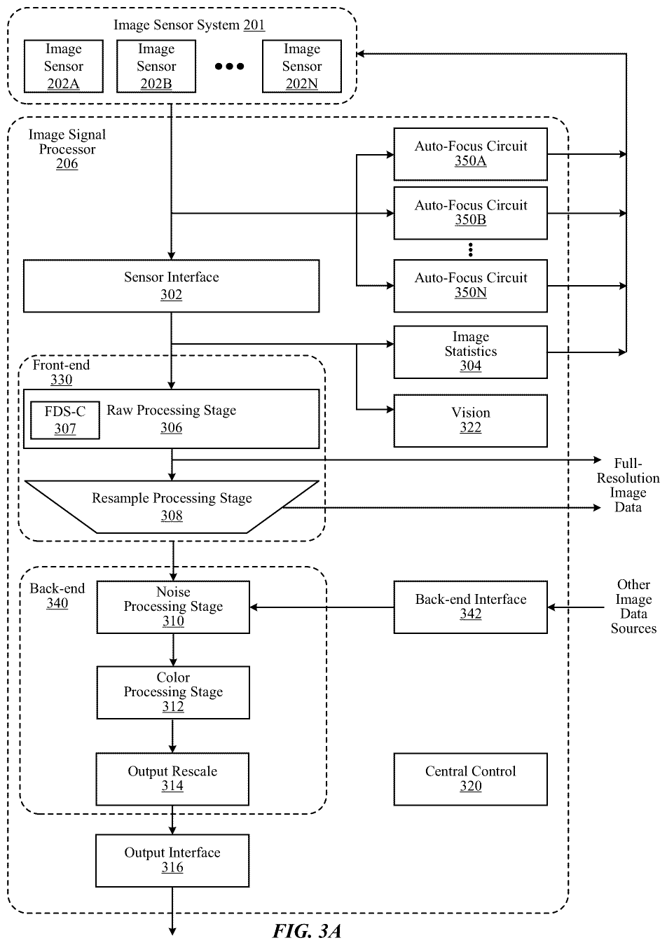

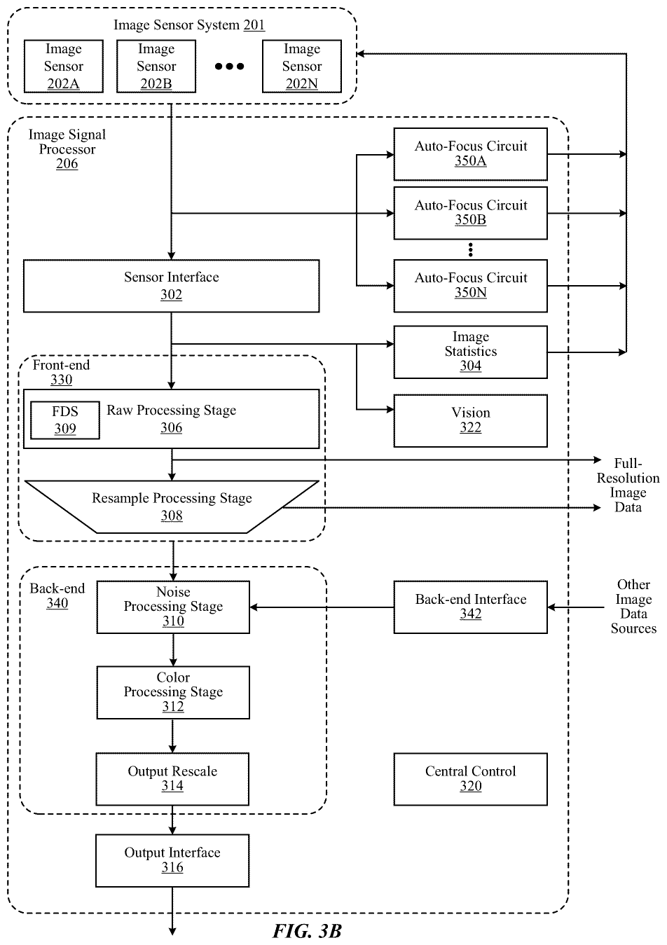

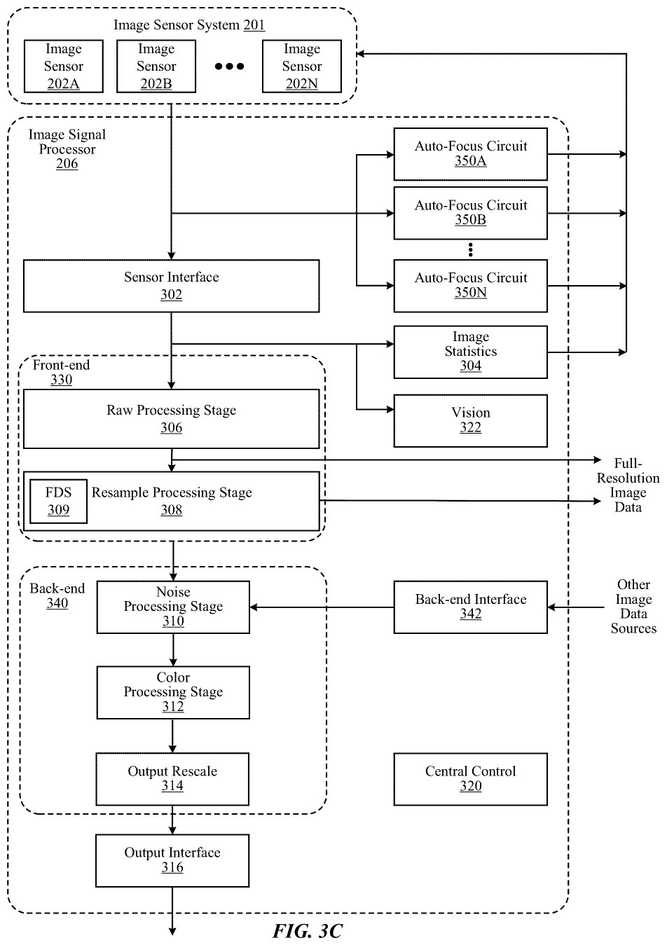

ISP 206 is hardware that performs various stages of an image processing pipeline. In some embodiments, ISP 206 may receive raw image data from image sensors 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations, as described below in detail with reference to FIG. 3A.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

GPU 220 is graphics processing circuitry for performing operations on graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

I/O interfaces 218 are hardware, software, firmware or combinations thereof for interfacing with various input/output components in device 100. I/O components may include devices such as keypads, buttons, audio devices, and sensors such as a global positioning system. I/O interfaces 218 process data for sending data to such I/O components or process data received from such I/O components.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to image signal processor 206, such as discussed below in FIG. 3A) and display. The networks may include, but are not limited to, Local Area Networks (LANs) (e.g., an Ethernet or corporate network) and Wide Area Networks (WANs). The image data received via network interface 210 may undergo image processing processes by ISP 206.

Motion sensor interface 212 is circuitry for interfacing with motion sensor 234. Motion sensor interface 212 receives sensor information from motion sensor 234 and processes the sensor information to determine the orientation or movement of the device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on ISP 206, CPU 208 or GPU 220. Such software components may be stored in system memory 230, persistent storage 228 or another device communicating with device 100 via network interface 210.

Image data or video data may flow through various data paths within SOC component 204. In one example, raw image data may be generated from image sensors 202 and processed by ISP 206, and then sent to system memory 230 via bus 232 and memory controller 222. After the image data is stored in system memory 230, it may be accessed by video encoder 224 for encoding or by display 216 for displaying via bus 232.

In another example, image data is received from sources other than image sensors 202. For example, video data may be streamed, downloaded, or otherwise communicated to the SOC component 204 via wired or wireless network. The image data may be received via network interface 210 and written to system memory 230 via memory controller 222. The image data may then be obtained by ISP 206 from system memory 230 and processed through one or more image processing pipeline stages, as described below in detail with reference to FIG. 3A. The image data may then be returned to system memory 230 or be sent to video encoder 224, display controller 214 (for display on display 216), or storage controller 226 for storage at persistent storage 228.

### Example Image Signal Processing Pipelines

FIG. 3A is a block diagram illustrating image processing pipelines implemented using ISP 206, according to one embodiment. In the embodiment of FIG. 3A, ISP 206 is coupled to an image sensor system 201 that includes one or more image sensors 202A through 202N (hereinafter collectively referred to as “image sensors 202” or also referred individually as “image sensor 202”) to receive raw image data. Image sensor system 201 may include one or more sub-systems that control image sensors 202 individually. In some cases, each image sensor 202 may operate independently while, in other cases, image sensors 202 may share some components. For example, in one embodiment, two or more image sensors 202 may share the same circuit board that controls the mechanical components of the image sensors (e.g., actuators that change the focal lengths of each image sensor). The image sensing components of image sensor 202 may include different types of image sensing components that may provide raw image data in different forms to ISP 206. For example, in one embodiment, the image sensing components may include multiple focus pixels that are used for auto-focusing and multiple image pixels that are used for capturing images. In another embodiment, the image sensing pixels may be used for both auto-focusing and image capturing purposes.

ISP 206 implements an image processing pipeline which may include a set of stages that process image information from creation, capture or receipt to output. ISP 206 may include, among other components, sensor interface 302, central control 320, front-end pipeline stages 330, back-end pipeline stages 340, image statistics module 304, vision module 322, back-end interface 342, output interface 316, and auto-focus circuits 350A through 350N (hereinafter collectively referred to as “auto-focus circuits 350” or referred individually as “auto-focus circuits 350”). ISP 206 may include other components not illustrated in FIG. 3A or may omit one or more components illustrated in FIG. 3A.

In one or more embodiments, different components of ISP 206 process image data at different rates. In the embodiment of FIG. 3A, front-end pipeline stages 330 (e.g., raw processing stage 306 and resample processing stage 308) may process image data at an initial rate. Thus, the various different techniques, adjustments, modifications, or other processing operations performed by these front-end pipeline stages 330 at the initial rate. For example, if front-end pipeline stages 330 process two pixels per clock cycle, then raw processing stage 306 operations (e.g., black level compensation, highlight recovery and defective pixel correction) may process two pixels of image data at a time. In contrast, one or more back-end pipeline stages 340 may process image data at a different rate less than the initial data rate. For example, in the embodiment of FIG. 3A, back-end pipeline stages 340 (e.g., noise processing stage 310, color processing stage 312, and output rescale 314) may be processed at a reduced rate (e.g., one pixel per clock cycle).

Raw image data captured by image sensors 202 may be transmitted to different components of ISP 206 in different manners. In one embodiment, raw image data corresponding to the focus pixels may be sent to auto-focus circuits 350 while raw image data corresponding to the image pixels may be sent to sensor interface 302. In another embodiment, raw image data corresponding to both types of pixels may simultaneously be sent to both auto-focus circuits 350 and sensor interface 302.

Auto-focus circuits 350 may include hardware circuit that analyzes raw image data to determine an appropriate focal length of each image sensor 202. In one embodiment, the raw image data may include data that is transmitted from image sensing pixels that specializes in image focusing. In another embodiment, raw image data from image capture pixels may also be used for auto-focusing purpose. Auto-focus circuit 350 may perform various image processing operations to generate data that determines the appropriate focal length. The image processing operations may include cropping, binning, image compensation, scaling to generate data that is used for auto-focusing purpose. The auto-focusing data generated by auto-focus circuits 350 may be fed back to image sensor system 201 to control the focal lengths of image sensors 202. For example, image sensor 202 may include a control circuit that analyzes the auto-focusing data to determine a command signal that is sent to an actuator associated with the lens system of image sensor 202 to change the focal length of image sensor 202. The data generated by auto-focus circuits 350 may also be sent to other components of ISP 206 for other image processing purposes. For example, some of the data may be sent to image statistics module 304 to determine information regarding auto-exposure.

Auto-focus circuits 350 may be individual circuits that are separate from other components such as image statistics module 304, sensor interface 302, front-end 330 and back-end 340. This allows ISP 206 to perform auto-focusing analysis independent of other image processing pipelines. For example, ISP 206 may analyze raw image data from image sensor 202A to adjust the focal length of image sensor 202A using auto-focus circuit 350A while performing downstream image processing of the image data from image sensor 202B simultaneously. In one embodiment, the number of auto-focus circuits 350 may correspond to the number of image sensors 202. In other words, each image sensor 202 may have a corresponding auto-focus circuit that is dedicated to the auto-focusing of image sensor 202. Device 100 may perform auto focusing for different image sensors 202 even if one or more image sensors 202 are not in active use. This allows a seamless transition between two image sensors 202 when device 100 switches from one image sensor 202 to another. For example, in one embodiment, device 100 may include a wide-angle camera and a telephoto camera as a dual back camera system for photo and image processing. Device 100 may display images captured by one of the dual cameras and may switch between the two cameras from time to time. The displayed images may seamless transition from image data captured by one image sensor 202 to image data captured by another image sensor 202 without waiting for second image sensor 202 to adjust its focal length because two or more auto-focus circuits 350 may continuously provide auto-focus data to image sensor system 201.

Raw image data captured by different image sensors 202 may also be transmitted to sensor interface 302. Sensor interface 302 receives raw image data from image sensors 202 and processes the raw image data into an image data processable by other stages in the pipeline. Sensor interface 302 may perform various preprocessing operations, such as image cropping, binning or scaling to reduce image data size. In some embodiments, pixels are sent from image sensors 202 to sensor interface 302 in raster order (e.g., horizontally, line by line). The subsequent processes in the pipeline may also be performed in raster order and the result may also be output in raster order. Although only a single image sensor system 201 and a single sensor interface 302 are illustrated in FIG. 3A, when more than one image sensor system is provided in device 100, a corresponding number of sensor interfaces may be provided in ISP 206 to process raw image data from each image sensor system.

Front-end pipeline stages 330 process image data in raw or full-color domains. Front-end pipeline stages 330 may include, but are not limited to, raw processing stage 306 and resample processing stage 308. A raw image data may be in a Bayer raw image format, for example. In the Bayer raw image format, pixel data with values specific to a particular color (instead of all colors) is provided in each pixel. In an image capturing sensor, image data is typically provided in the Bayer pattern. Raw processing stage 306 may process image data in the Bayer raw image format.

The operations performed by raw processing stage 306 include, but are not limited, sensor linearization, black level compensation, fixed pattern noise reduction, defective pixel correction, raw noise filtering, lens shading correction, white balance gain, highlight recovery, and chromatic aberration recovery (or correction). Sensor linearization refers to mapping non-linear image data to linear space for other processing. Black level compensation refers to providing digital gain, offset and clip independently for each color component (e.g., Gr, R, B, Gb) of the image data. Fixed pattern noise reduction refers to removing offset fixed pattern noise and gain fixed pattern noise by subtracting a dark frame from an input image and multiplying different gains to pixels. Defective pixel correction refers to detecting defective pixels, and then replacing defective pixel values. Raw noise filtering refers to reducing noise of image data by averaging neighbor pixels that are similar in brightness. Highlight recovery refers to estimating pixel values for those pixels that are clipped (or nearly clipped) from other channels. Lens shading correction refers to applying a gain per pixel to compensate for a dropoff in intensity roughly proportional to a distance from a lens optical center. White balance gain refers to providing digital gains for white balance, offset and clip independently for all color components (e.g., Gr, R, B, Gb in the Bayer pattern).

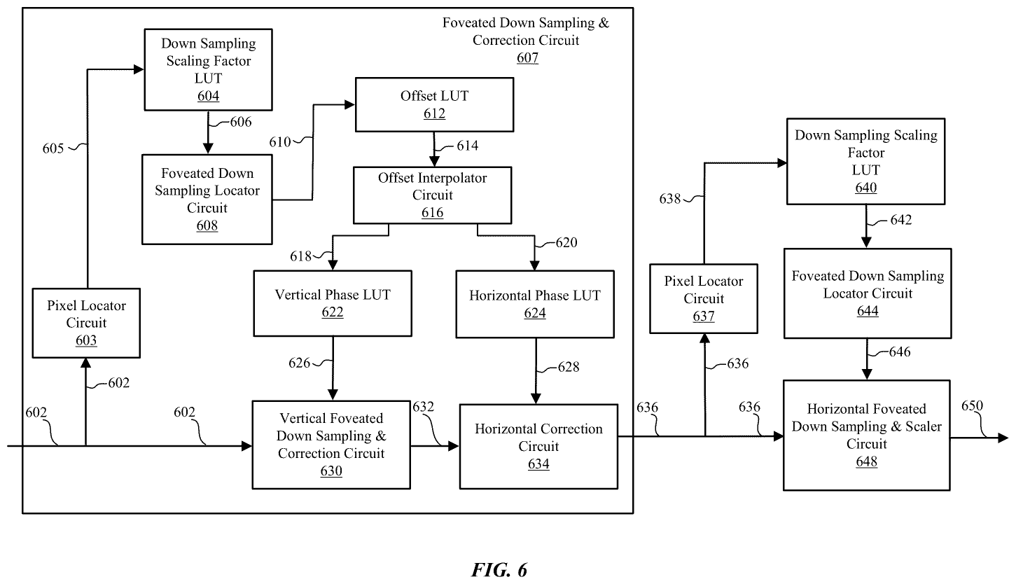

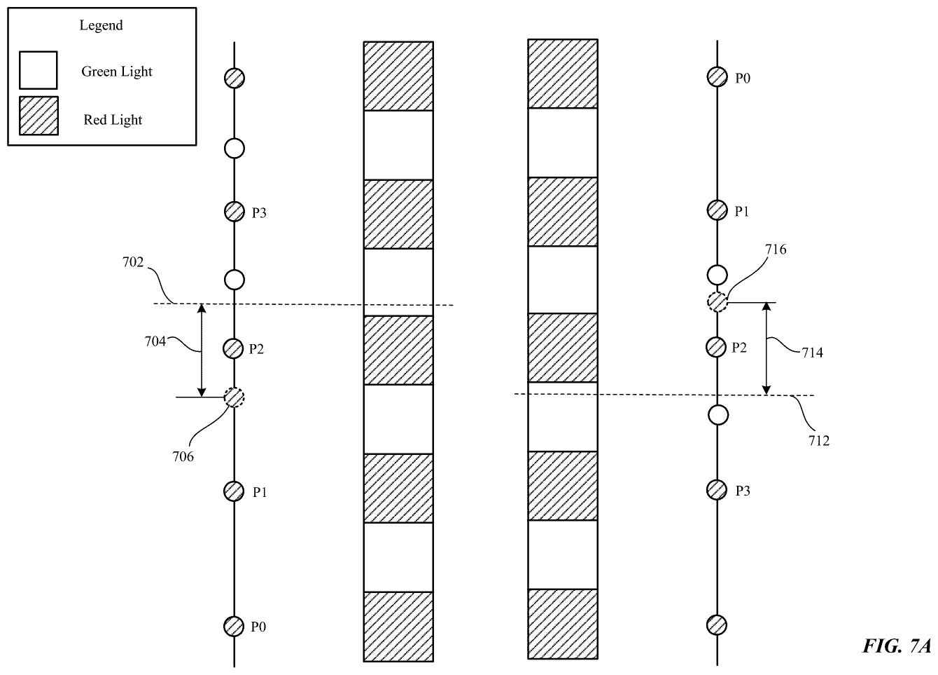

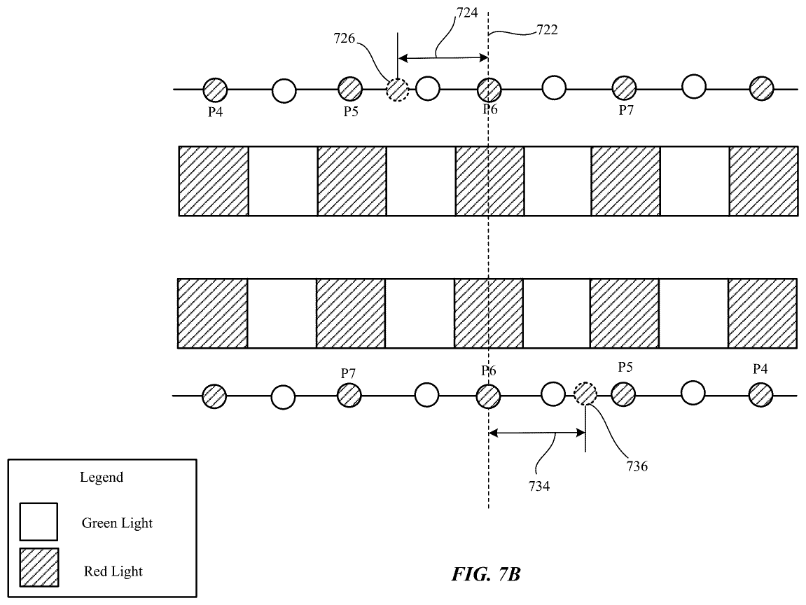

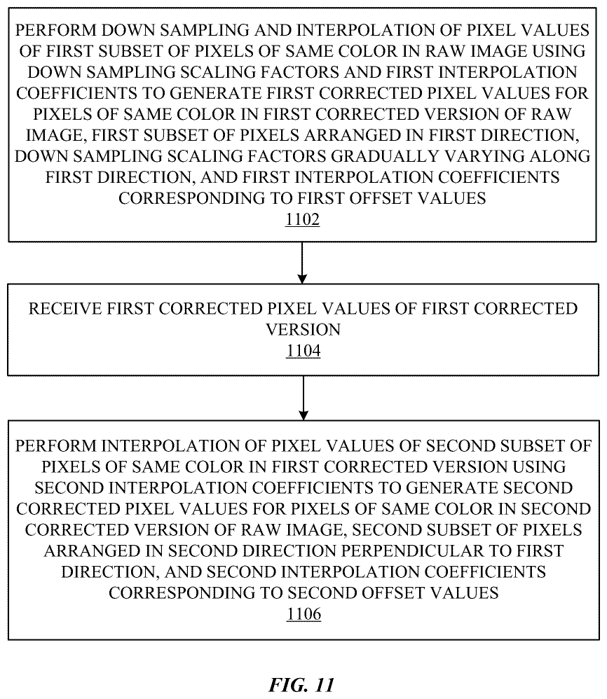

A foveated down sampling and correction (FDS-C) circuit 307 in raw processing stage 306 performs the chromatic aberration recovery by performing foveated down sampling and aberration correction. The chromatic aberration recovery performed by FDS-C circuit 307 refers to correcting chromatic aberrations in raw image data resulting from the use of wide-angle lenses in image sensors 202 to generate raw images. Details about a structure and operation of FDS-C circuit 307 are provided below in relation to FIG. 6, FIGS. 7A-7B, and FIG. 11. Components of ISP 206 may convert raw image data into image data in full-color domain, and thus, raw processing stage 306 may process image data in the full-color domain in addition to or instead of raw image data.

Resample processing stage 308 performs various operations to convert, resample, or scale image data received from raw processing stage 306. Operations performed by resample processing stage 308 may include, but not limited to, demosaic operation, per-pixel color correction operation, Gamma mapping operation, color space conversion and downscaling or sub-band splitting. Demosaic operation refers to converting or interpolating missing color samples from raw image data (for example, in the Bayer pattern) to output image data into a full-color domain. Demosaic operation may include low pass directional filtering on the interpolated samples to obtain full-color pixels. Per-pixel color correction operation refers to a process of performing color correction on a per-pixel basis using information about relative noise standard deviations of each color channel to correct color without amplifying noise in the image data. Gamma mapping refers to converting image data from input image data values to output data values to perform gamma correction. For the purpose of Gamma mapping, lookup tables (or other structures that index pixel values to another value) for different color components or channels of each pixel (e.g., a separate lookup table for R, G, and B color components) may be used. Color space conversion refers to converting color space of an input image data into a different format. In one embodiment, resample processing stage 308 converts RGB format into YCbCr format for further processing. In another embodiment, resample processing state 308 concerts RBD format into RGB format for further processing.

Central control module 320 may control and coordinate overall operation of other components in ISP 206. Central control module 320 performs operations including, but not limited to, monitoring various operating parameters (e.g., logging clock cycles, memory latency, quality of service, and state information), updating or managing control parameters for other components of ISP 206, and interfacing with sensor interface 302 to control the starting and stopping of other components of ISP 206. For example, central control module 320 may update programmable parameters for other components in ISP 206 while the other components are in an idle state. After updating the programmable parameters, central control module 320 may place these components of ISP 206 into a run state to perform one or more operations or tasks. Central control module 320 may also instruct other components of ISP 206 to store image data (e.g., by writing to system memory 230 in FIG. 2) before, during, or after resample processing stage 308. In this way full-resolution image data in raw or full-color domain format may be stored in addition to or instead of processing the image data output from resample processing stage 308 through backend pipeline stages 340.

Image statistics module 304 performs various operations to collect statistic information associated with the image data. The operations for collecting statistics information may include, but not limited to, sensor linearization, replace patterned defective pixels, sub-sample raw image data, detect and replace non-patterned defective pixels, black level compensation, lens shading correction, and inverse black level compensation. After performing one or more of such operations, statistics information such as 3A statistics (auto white balance (AWB), auto exposure (AE), histograms (e.g., 2D color or component) and any other image data information may be collected or tracked. In some embodiments, certain pixels' values, or areas of pixel values may be excluded from collections of certain statistics data when preceding operations identify clipped pixels. Although only a single statistics module 304 is illustrated in FIG. 3A, multiple image statistics modules may be included in ISP 206. For example, each image sensor 202 may correspond to an individual image statistics module 304. In such embodiments, each statistic module may be programmed by central control module 320 to collect different information for the same or different image data.

Vision module 322 performs various operations to facilitate computer vision operations at CPU 208 such as facial detection in image data. Vision module 322 may perform various operations including pre-processing, global tone-mapping and Gamma correction, vision noise filtering, resizing, keypoint detection, generation of histogram-of-orientation gradients (HOG) and normalized cross correlation (NCC). The pre-processing may include subsampling or binning operation and computation of luminance if the input image data is not in YCrCb format. Global mapping and Gamma correction can be performed on the pre-processed data on luminance image. Vision noise filtering is performed to remove pixel defects and reduce noise present in the image data, and thereby, improve the quality and performance of subsequent computer vision algorithms. Such vision noise filtering may include detecting and fixing dots or defective pixels, and performing bilateral filtering to reduce noise by averaging neighbor pixels of similar brightness. Various vision algorithms use images of different sizes and scales. Resizing of an image is performed, for example, by binning or linear interpolation operation. Keypoints are locations within an image that are surrounded by image patches well suited to matching in other images of the same scene or object. Such keypoints are useful in image alignment, computing camera pose and object tracking. Keypoint detection refers to the process of identifying such keypoints in an image. HOG provides descriptions of image patches for tasks in mage analysis and computer vision. HOG can be generated, for example, by (i) computing horizontal and vertical gradients using a simple difference filter, (ii) computing gradient orientations and magnitudes from the horizontal and vertical gradients, and (iii) binning the gradient orientations. NCC is the process of computing spatial cross-correlation between a patch of image and a kernel.

Back-end interface 342 receives image data from other image sources than image sensor 202 and forwards it to other components of ISP 206 for processing. For example, image data may be received over a network connection and be stored in system memory 230. Back-end interface 342 retrieves the image data stored in system memory 230 and provides it to back-end pipeline stages 340 for processing. One of many operations that are performed by back-end interface 342 is converting the retrieved image data to a format that can be utilized by back-end processing stages 340. For instance, back-end interface 342 may convert RGB, YCbCr 4:2:0, or YCbCr 4:2:2 formatted image data into YCbCr 4:4:4 color format.

Back-end pipeline stages 340 processes image data according to a particular full-color format (e.g., YCbCr 4:4:4 or RGB). In some embodiments, components of the back-end pipeline stages 340 may convert image data to a particular full-color format before further processing. Back-end pipeline stages 340 may include, among other stages, noise processing stage 310 and color processing stage 312. Back-end pipeline stages 340 may include other stages not illustrated in FIG. 3A.

Noise processing stage 310 performs various operations to reduce noise in the image data. The operations performed by noise processing stage 310 include, but are not limited to, color space conversion, gamma/de-gamma mapping, temporal filtering, noise filtering, luma sharpening, and chroma noise reduction. The color space conversion may convert an image data from one color space format to another color space format (e.g., RGB format converted to YCbCr format). Gamma/de-gamma operation converts image data from input image data values to output data values to perform gamma correction or reverse gamma correction. Temporal filtering filters noise using a previously filtered image frame to reduce noise. For example, pixel values of a prior image frame are combined with pixel values of a current image frame. Noise filtering may include, for example, spatial noise filtering. Luma sharpening may sharpen luma values of pixel data while chroma suppression may attenuate chroma to gray (e.g., no color). In some embodiment, the luma sharpening and chroma suppression may be performed simultaneously with spatial nose filtering. The aggressiveness of noise filtering may be determined differently for different regions of an image. Spatial noise filtering may be included as part of a temporal loop implementing temporal filtering. For example, a previous image frame may be processed by a temporal filter and a spatial noise filter before being stored as a reference frame for a next image frame to be processed. In other embodiments, spatial noise filtering may not be included as part of the temporal loop for temporal filtering (e.g., the spatial noise filter may be applied to an image frame after it is stored as a reference image frame and thus the reference frame is not spatially filtered.

Color processing stage 312 may perform various operations associated with adjusting color information in the image data. The operations performed in color processing stage 312 include, but are not limited to, local tone mapping, gain/offset/clip, color correction, three-dimensional color lookup, gamma conversion, and color space conversion. Local tone mapping refers to spatially varying local tone curves in order to provide more control when rendering an image. For instance, a two-dimensional grid of tone curves (which may be programmed by central control module 320) may be bilinearly interpolated such that smoothly varying tone curves are created across an image. In some embodiments, local tone mapping may also apply spatially varying and intensity varying color correction matrices, which may, for example, be used to make skies bluer while turning down blue in the shadows in an image. Digital gain/offset/clip may be provided for each color channel or component of image data. Color correction may apply a color correction transform matrix to image data. 3D color lookup may utilize a three-dimensional array of color component output values (e.g., R, G, B) to perform advanced tone mapping, color space conversions, and other color transforms. Gamma conversion may be performed, for example, by mapping input image data values to output data values in order to perform gamma correction, tone mapping, or histogram matching. Color space conversion may be implemented to convert image data from one color space to another (e.g., RGB to YCbCr). Other processing techniques may also be performed as part of color processing stage 312 to perform other special image effects, including black and white conversion, sepia tone conversion, negative conversion, or solarize conversion.

Output rescale module 314 may resample, transform and correct distortion on the fly as ISP 206 processes image data. Output rescale module 314 may compute a fractional input coordinate for each pixel and uses this fractional coordinate to interpolate an output pixel via a polyphase resampling filter. A fractional input coordinate may be produced from a variety of possible transforms of an output coordinate, such as resizing or cropping an image (e.g., via a simple horizontal and vertical scaling transform), rotating and shearing an image (e.g., via non-separable matrix transforms), perspective warping (e.g., via an additional depth transform) and per-pixel perspective divides applied in piecewise in strips to account for changes in image sensor during image data capture (e.g., due to a rolling shutter), and geometric distortion correction (e.g., via computing a radial distance from the optical center in order to index an interpolated radial gain table, and applying a radial perturbance to a coordinate to account for a radial lens distortion).

Output rescale module 314 may apply transforms to image data as it is processed at output rescale module 314. Output rescale module 314 may include horizontal and vertical scaling components. The vertical portion of the design may implement series of image data line buffers to hold the “support” needed by the vertical filter. As ISP 206 may be a streaming device, it may be that only the lines of image data in a finite-length sliding window of lines are available for the filter to use. Once a line has been discarded to make room for a new incoming line, the line may be unavailable. Output rescale module 314 may statistically monitor computed input Y coordinates over previous lines and use it to compute an optimal set of lines to hold in the vertical support window. For each subsequent line, output rescale module may automatically generate a guess as to the center of the vertical support window. In some embodiments, the output rescale module 314 may implement a table of piecewise perspective transforms encoded as digital difference analyzer (DDA) steppers to perform a per-pixel perspective transformation between an input image data and output image data in order to correct artifacts and motion caused by sensor motion during the capture of the image frame. Output rescale may provide image data via output interface 316 to various other components of device 100, as discussed above in relation to FIGS. 1 and 2.

In various embodiments, the functionally of components 302 through 350 may be performed in a different order than the order implied by the order of these functional units in the image processing pipeline illustrated in FIG. 3A, or may be performed by different functional components than those illustrated in FIG. 3A. Moreover, the various components as described in FIG. 3A may be embodied in various combinations of hardware, firmware or software.

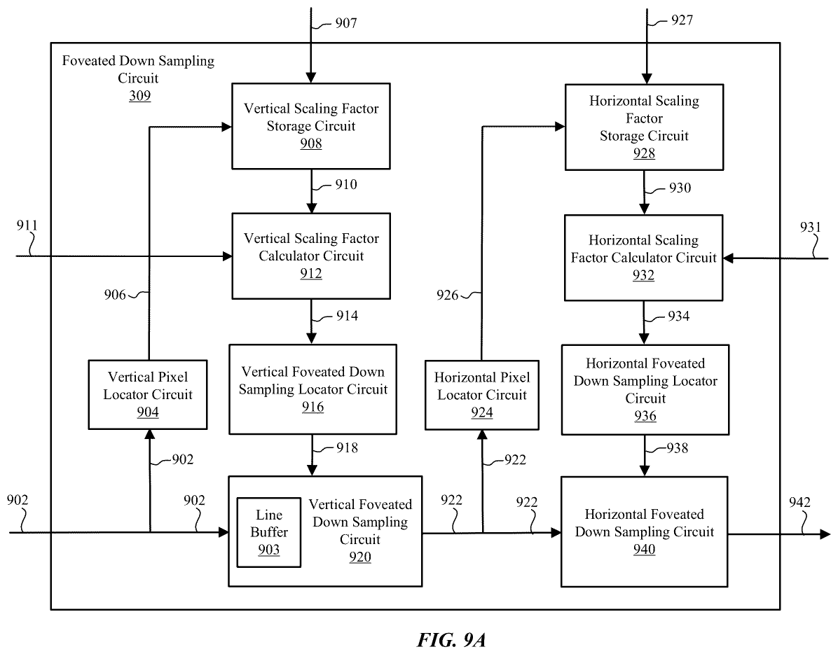

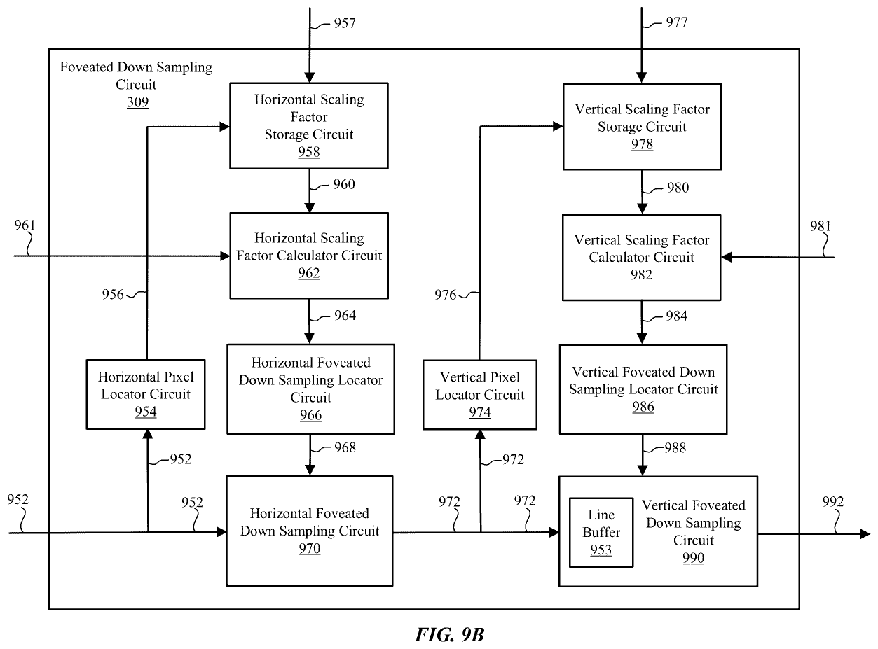

FIG. 3B is another block diagram illustrating image processing pipelines implemented using ISP 206, according to one embodiment. The image processing pipelines in FIG. 3B correspond to the image processing pipelines in FIG. 3A. The image processing pipelines of FIG. 3B are substantially identical to those of FIG. 3A except that raw processing stage 306 includes a foveated down sampling (FDS) circuit 309 for performing foveated down sampling on pixels of raw image data. FIG. 3C is another block diagram illustrating image processing pipelines implemented using ISP 206, according to one embodiment. The image processing pipelines in FIG. 3C are substantially identical to those of FIG. 3B except that, instead of being part of raw processing stage 306, FDS circuit 309 is integrated into resample processing stage 308. In such case, FDS circuit 309 may perform foveated down sampling on different color channels (e.g., R, G, B color channels) of pixels of image data having a color format (e.g., RGB format). Details about a structure and operation of FDS circuit 309 are provided below in relation to FIGS. 9A-9B, 10A-10C, and 12.

### Example Foveated Down Sampling

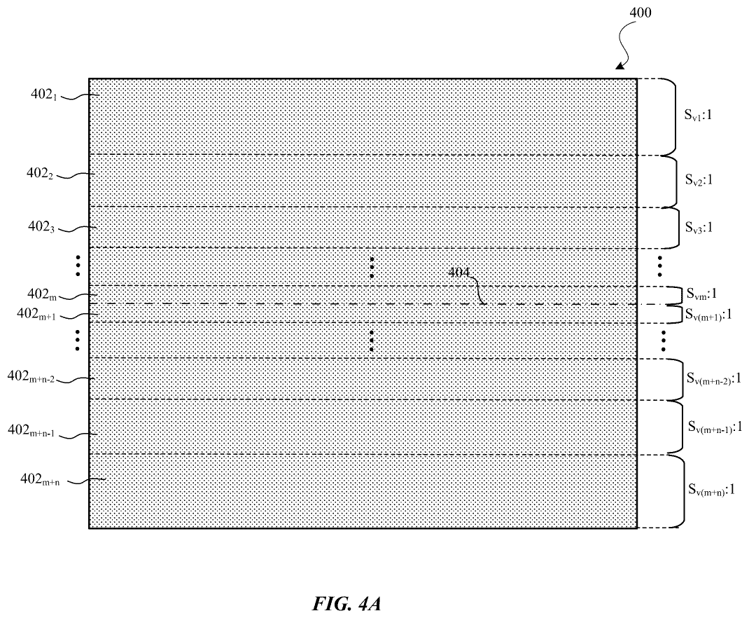

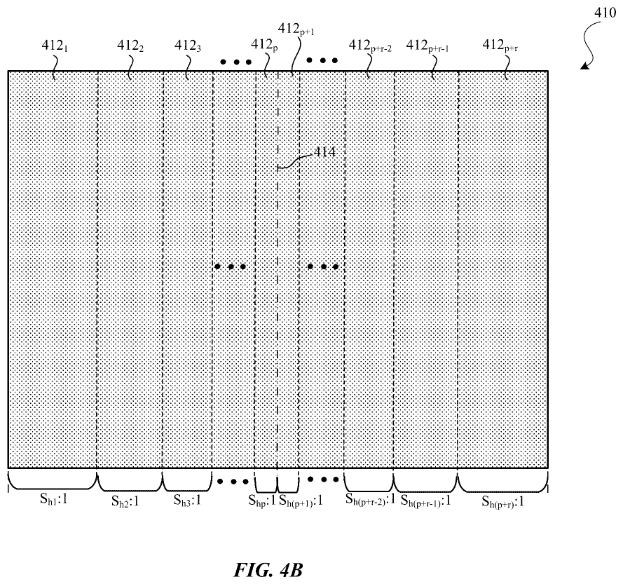

FIG. 4A is an example vertical foveated down sampling of an image 400, according to one embodiment. Image 400 may be processed by down sampling pixels in image 400 along a first direction (e.g., vertical direction). Image 400 may be a raw image obtained by one or more image sensors 202. Image 400 may be divided into scaling sections 402₁, 402₂, 402₃, . . . , 402ₘ, 402ₘ₊₁, 402ₘ₊ₙ₋₂, 402ₘ₊ₙ₋₁, 402ₘ₊ₙ, where m and n are integers. In one embodiment, image 400 is divided into uniform scaling sections 402₁ through 402ₘ₊ₙ. In such case, all scaling sections (e.g., all vertical down sampling steps) 402₁ through 402ₘ₊ₙ are the same. In another embodiment, image 400 is divided into non-uniform scaling sections 402₁ through 402ₘ₊ₙ. In such case, one or more of scaling sections (e.g., one or more down sampling steps) 402₁ through 402ₘ₊ₙ are different from other scaling sections in image 400. In some embodiments, two or more of scaling sections 402₁ through 402ₘ₊ₙ may be grouped into a single scaling section associated with a same scaling factor (e.g., same down sampling ratio). Some of the scaling sections 402₁ through 402ₘ₊ₙ may have a size of a single pixel where, e.g., no down sampling is performed. A size of each scaling section (e.g., down sampling step) and the number of scaling sections (e.g., number of down sampling steps) in image 400 may be configurable.

Pixels in each scaling section 402₁ through 402ₘ₊ₙ may be down sampled along the vertical direction using a corresponding down sampling (or scaling) ratio Sᵥ₁:1, Sᵥ₂:1, Sᵥ₃:1, . . . , Sᵥₘ:1, Sᵥ₍ₘ₊₁₎: 1, . . . , Sᵥ₍ₘ₊ₙ₋₂₎:1, Sᵥ₍ₘ₊ₙ₋₁₎:1, Sᵥ₍ₘ₊ₙ₎: 1, where Sᵥ₁ through Sᵥ₍ₘ₊ₙ₎ are corresponding down sampling (or scaling) factors, and Sᵥ₁>Sᵥ₂>Sᵥ₃> . . . >Sᵥₘ≤Sᵥ₍ₘ₊₁₎<Sᵥ₍ₘ₊ₙ₋₂₎<Sᵥ₍ₘ₊ₙ₋₁₎> . . . <Sᵥ₍ₘ₊ₙ₎. In one or more embodiments, Sᵥ₁=Sᵥ₍ₘ₊ₙ₎, Sᵥ₂=Sᵥ₍ₘ₊ₙ₋₁₎, Sᵥ₃=Sᵥ₍ₘ₊ₙ₋₂₎, and Sᵥₘ=Sᵥ₍ₘ₊₁₎. Additionally, at least one scaling factor may be equal to 1, e.g., pixels in at least one corresponding scaling section may not be down sampled. For example, the scaling factor Sᵥₘ is equal to 1 and/or the scaling factor Sᵥ₍ₘ₊₁₎ is equal to 1, and pixels in scaling sections 402ₘ and 402ₘ₊₁ (e.g., scaling sections in a defined vicinity of a center axis 404) may not be down sampled.

In one illustrative example, image 400 may be divided into a total of three scaling sections. In such case, peripheral scaling sections 402₁ through 402ₘ₋₁ can be grouped into a single scaling section with a scaling factor of 2 (e.g., down sampling ratio of 2:1), central (e.g., foveated) scaling sections 402ₘ and 402ₘ₊₁ (and one or more additional scaling sections in a defined vicinity from central axis 404) may be grouped into a single scaling section with a scaling factor of 1 (e.g., down sampling ratio of 1:1) where no vertical down sampling is performed, and peripheral scaling sections 402ₘ₊₂ through 402ₘ₊ₙ may be grouped into a single scaling section with a scaling factor of 2 (e.g., down sampling ratio of 2:1).

In a first vertical foveated down sampling mode, scaling factors Sᵥ₁ through Sᵥ₍ₘ₊ₙ₎ may vary gradually, e.g., at one or more rates that are less than a threshold rate. In a second vertical foveated down sampling mode, scaling factors Sᵥ₁ through Sᵥ₍ₘ₊ₙ₎ may vary non-gradually, e.g., at one or more rates that are greater than the threshold rate. A mode of the vertical foveated down sampling mode may be configurable. Details about hardware implementation of a vertical foveated down sampling combined with chromatic aberration recovery are provided below in relation to FIG. 6. Details about hardware implementation of a stand-alone vertical foveated down sampling are provided below in relation to FIGS. 9A and 9B.

FIG. 4B is an example horizontal foveated down sampling of an image 410, according to one embodiment. Image 410 may be processed by down sampling pixels along a second direction (e.g., horizontal direction). Image 410 may be an image obtained after performing the vertical foveated down sampling of image 400, as shown in FIG. 4A. In such case, the horizontal foveated down sampling illustrated in FIG. 4B is performed after the vertical foveated down sampling of FIG. 4A. Alternatively, image 410 may be a raw image obtained by one or more image sensors 202. In such case, the horizontal foveated down sampling illustrated in FIG. 4B is performed prior to the vertical foveated down sampling of FIG. 4A.

Image 410 may be divided into scaling sections 412₁, 412₂, 412₃, . . . , 412ₘ, 412ₘ₊₁, . . . , 412ₚ₊ᵣ₋₂, 402ₚ₊ᵣ₋₁, 402ₚ₊ᵣ, where p and r are integers. In one embodiment, image 410 is divided into uniform scaling sections 412₁ through 412ₚ₊ᵣ. In such case, all scaling sections (e.g., all vertical down sampling steps) 412₁ through 412ₚ₊ᵣ are the same. In another embodiment, image 400 is divided into non-uniform scaling sections 412₁ through 412ₘ₊ₙ. In such case, one or more scaling sections (e.g., one or more down sampling steps) 412₁ through 412ₚ₊ᵣ are different from other scaling sections in image 410. In some embodiments, two or more of scaling sections 412₁ through 412ₚ₊ᵣ may be grouped into a single scaling section associated with a same scaling factor (e.g., same down sampling ratio). Some of the scaling sections 412₁ through 412ₚ₊ᵣ may have a size of a single pixel where, e.g., no down sampling is performed. A size of each scaling section (e.g., down sampling step) and the number of scaling sections (e.g., number of down sampling steps) in image 410 may be configurable.

Pixels in each scaling section 412₁ through 412ₚ₊ᵣ may be down sampled along the horizontal direction using a corresponding down sampling (or scaling) ratio Sₕ₁:1, Sₕ₂:1, Sₕ₃:1, . . . , Sₕₚ:1, Sₕ₍ₚ₊₁₎:1, . . . , Sₕ₍ₚ₊ᵣ₋₂₎:1, Sₕ₍ₚ₊ᵣ₋₁₎:1, Sₕ₍ₚ₊ᵣ₎:1, where Sₕ₁ through S_{h(p+q)} are corresponding down sampling (or scaling) factors, and Sₕ₁>Sₕ₂>Sₕ₃> . . . >Sₕₘ≤Sₕ₍ₚ₊₁₎<Sₕ₍ₚ₊ᵣ₋₂₎<Sₕ₍ₚ₊ᵣ₋₁₎<Sₕ₍ₚ₊ᵣ₎. In one or more embodiments, Sₕ₁=Sₕ₍ₚ₊₂₎, Sₕ₂=Sₕ₍ₚ₊ᵣ₋₁₎, Sₕ₃=Sₕ₍ₚ₊ᵣ₋₂₎, and Sₕₚ=Sₕ₍ₚ₊₁₎. Additionally, at least one scaling factor may be equal to 1, e.g., pixels in at least one corresponding scaling section may not be down sampled. For example, the scaling factor Sₕₚ is equal to 1 and/or the scaling factor Sₕ₍ₚ₊₁₎ is equal to 1, and pixels in scaling sections 412ₚ and 402ₚ₊₁ (e.g., scaling sections in a defined vicinity of a center axis 414) may not be down sampled.

In one illustrative example, image 410 may be divided into a total of three scaling sections. In such case, peripheral scaling sections 412₁ through 412ₚ₋₁ can be grouped into a single scaling section with a scaling factor of 2 (e.g., down sampling ratio of 2:1), central (e.g., foveated) scaling sections 412ₚ and 412ₚ₊₁ (and one or more additional scaling sections in a defined vicinity from central axis 414) may be grouped into a single scaling section with a scaling factor of 1 (e.g., down sampling ratio of 1:1) where no vertical down sampling is performed, and peripheral scaling sections 412ₘ₊₂ through 412ₘ₊ₙ may be grouped into a single scaling section with a scaling factor of 2 (e.g., down sampling ratio of 2:1).

In a first horizontal foveated down sampling mode, scaling factors Sₕ₁ through Sₕ₍ₚ₊ᵣ₎ may vary gradually, e.g., at one or more rates that are less than a threshold rate. In a second horizontal foveated down sampling mode, scaling factors Sₕ₁ through Sₕ₍ₚ₊ᵣ₎ may vary non-gradually, e.g., at one or more rates that are greater than the threshold rate. A mode of the horizontal foveated down sampling may be configurable. Details about hardware implementation of a horizontal foveated down sampling combined with chromatic aberration recovery are provided below in relation to FIG. 6. Details about hardware implementation of a stand-alone horizontal foveated down sampling are provided below in relation to FIGS. 9A and 9B.

### Example Chromatic Aberration Recovery

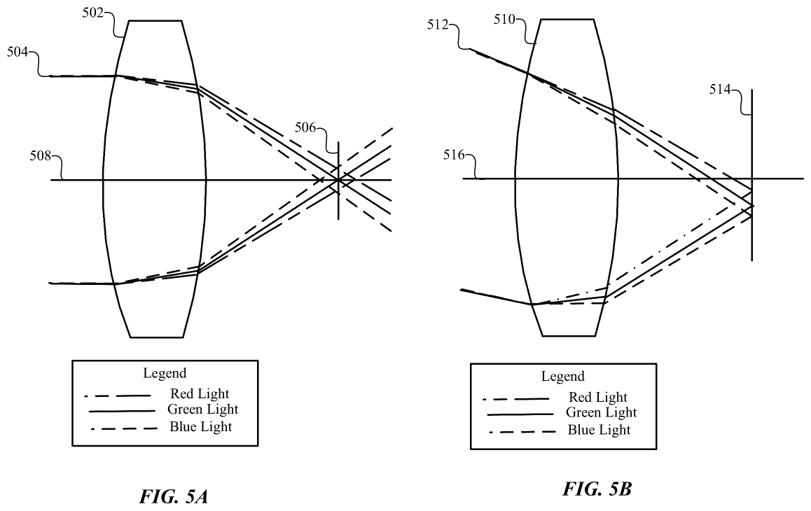

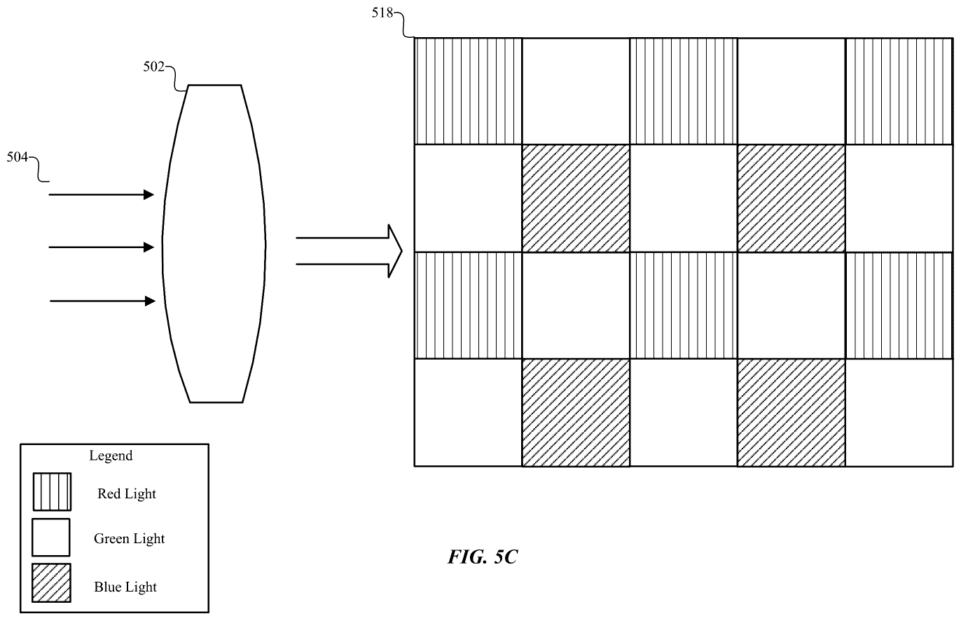

In general, chromatic aberration is caused by the inability of a lens to focus different wavelengths of light (e.g., different colors of light) to the same focal point. FIG. 5A illustrates an example of longitudinal (e.g., axial) chromatic aberration. As shown in FIG. 5A, a wide-angle lens 502 refracts light 504 such that different wavelengths of light (e.g., red light, green light, and blue light) are focused at different distances from wide-angle lens 502 (e.g., at different distances from a focal plane 506) along an optical axis 508. FIG. 5B illustrates lateral (e.g., transverse) chromatic aberration, according to one embodiment. As shown in FIG. 5B, a wide-angle lens 510 refracts light 512 such that different wavelengths of light (e.g., red light, green light, and blue light) are focused at different positions on a focal plane 514 (e.g., at different distances from an optical axis 516). Chromatic aberration due to the usage of wide-angle lenses 502, 510 as described with respect to FIGS. 5A and 5B manifests itself as color fringing at edges in full color images.

FIG. 5C illustrates raw image data generated using light 504 captured by image sensor 202 using wide-angle lens 502, according to one embodiment. As shown in FIG. 5C, the raw image data is in a Bayer pattern 518. Bayer pattern 518 includes alternating rows of red-green pixels and green-blue pixels. Generally, Bayer pattern 518 includes more green pixels than red or blue pixels due to the human eye being more sensitive to green light than both red light and blue light.

### Example Foveated Down Sampling and Correction Circuit

FIG. 6 is a block diagram illustrating a detailed view of a foveated down sampling and correction (FDS-C) circuit 307, according to one embodiment. FDS-C circuit 307 corrects chromatic aberrations in raw image 602 generated by one or more image sensors 202. Specifically, FDS-C circuit 307 performs combined foveated down sampling and chromatic aberration recovery in a first direction (e.g., vertical direction) of raw image 602 to generate first corrected pixel values 632 of a first corrected version of raw image. FDS-C circuit 307 further performs chromatic aberration recovery in a second direction (e.g., horizontal direction) of the first corrected version of raw image to generate second corrected pixel values 636 of a second corrected version of raw image with reduced chromatic aberrations. In one or more embodiments, raw image 602 is in the Bayer pattern and is generated by at least one image sensor 202 using at least one wide-angle lens as described with respect to FIG. 5C. A full-color image directly generated from raw image 602 would include chromatic aberrations due to utilizing the at least one wide-angle lens to generate raw image 602. By using second corrected pixel values 636 of the second corrected version to generate a full-color image rather than raw image 602, chromatic aberrations in the full-color image are reduced.

In one embodiment, FDS-C circuit 307 includes a pixel locator circuit 603, down sampling scaling factor look-up table (LUT) 604, a foveated down sampling locator circuit 608, an offset LUT 612, an offset interpolator circuit 616, a vertical phase LUT 622, a horizontal phase LUT 624, a vertical foveated down sampling and correction circuit 630, and a horizontal correction circuit 634. Additionally, FDS-C circuit 307 is coupled to a horizontal foveated down sampling and scaler circuit 648. In other embodiments, FDS-C circuit 307 may have additional or fewer circuits and LUTs than those shown in FIG. 6. For example, horizontal foveated down sampling and scaler circuit 648 may be part of FDS-C circuit 307.

Down sampling scaling factor LUT 604 stores down sampling scaling factors indexed by locations in a first direction (e.g., vertical direction) of an image (e.g., raw image 602). Down sampling scaling factor LUT 604 receives indexing information 605 related to a location of a corresponding pixel along the first direction in raw image 602. Indexing information 605 for the corresponding pixel along the first direction in raw image 602 is extracted by pixel locator circuit 603. Upon receiving indexing information 605, down sampling scaling factor LUT 604 outputs a corresponding down sampling scaling factor 606 that is passed onto foveated down sampling pixel locator circuit 608.

Foveated down sampling locator circuit 608 receives down sampling scaling factor 606 from down sampling scaling factor LUT 604, and calculates a down sampling pixel location 610 (e.g., a down sampling landing) along the first direction of raw image 602. Information about down sampling pixel location 610 calculated by foveated down sampling locator circuit 608 is provided to offset LUT 612.

Offset LUT 612 stores a grid of pre-calculated horizontal and vertical offset values. A horizontal offset value and a vertical offset value for a certain pixel represent, respectively, a horizontal distance and a vertical distance to a virtual pixel with a pixel value that corresponds to a pixel value of the certain pixel had there not been any chromatic aberrations. The grid includes multiple grid points having multiple pixel offset values. The pre-calculated offset values in the grid may be associated with optical configurations of a corresponding image sensor 202 (e.g., use of a specific wide-angle lens). Thus, offset LUT 612 may store different sets of offset values that are each associated with different image sensors 202. In one or more embodiments, the grid is coarser than the arrangement of pixels of Bayer pattern 502. A particular pixel location may be associated with one or more grid points and includes four pixel offset values: a horizontal pixel offset value for the red pixels, a vertical pixel offset value for the red pixels, a horizontal offset value for the blue pixels, and a vertical offset value for the blue pixels. Horizontal offset values for the green pixels and vertical offset values for the green pixels may be set to zeroes.

Upon receiving information about down sampling pixel locations 610 in the first direction of raw image 602, offset LUT 612 may provide corresponding vertical offset values 614 to offset interpolator circuit 616. Furthermore, offset LUT 612 may provide corresponding horizontal offset values 614 to offset interpolator circuit 616 based on information about locations of a subset of pixels of raw image 602 arranged in a second direction (e.g., horizontal direction) perpendicular to the first direction.

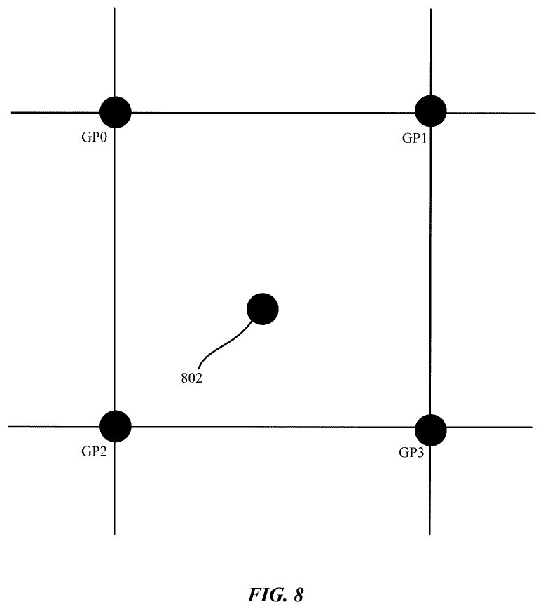

Offset interpolator circuit 616 is coupled to offset LUT 612 and receives pre-calculated horizontal and vertical offset values 614 from offset LUT 612. In one embodiment, offset interpolator circuit 616 calculates horizontal and vertical offset values for subsets of pixels (e.g., blue and red pixels) included in raw image 602. Specifically, offset interpolator circuit 616 calculates first offset values 618 (e.g., vertical offset values) of a blue or red pixel by performing interpolation on pre-calculated vertical offset values 614. Furthermore, offset interpolator circuit 616 calculates second offset values 620 (e.g., horizontal offset values) of a blue or red pixel by performing interpolation on pre-calculated vertical offset values of grid points surrounding the blue or red pixel as described below with reference to FIG. 8. That is, for each red or blue pixel in raw image 602, offset interpolator circuit 616 calculates a horizonal pixel offset for the red color channel of the pixel, a vertical pixel offset value for the red color channel of the pixel, a horizonal pixel offset for the blue color channel of the pixel, and a vertical pixel offset value for the blue color channel of the pixel. In one or more embodiments, offset interpolator circuit 616 does not calculate vertical and horizontal pixel offsets for the green color channel of the pixel (e.g., vertical and horizontal pixel offsets for the green color channel are zero). However, in one or more other embodiments, offset interpolator circuit 616 may also calculate a horizontal pixel offset for the green color channel of the pixel and a vertical pixel offset value for the green color channel of the pixel. Generally, when the horizontal and vertical pixel offsets for two color channels are calculated, the horizontal and vertical pixel offsets for the remaining color channel (RGB) are not calculated.

FIG. 7A illustrates vertical foveated down sampling and interpolation based on vertical offset pixel correction for a red color channel of a subset of pixels included in raw image 602, according to one embodiment. Due to chromatic aberration in the vertical direction, the pixel value of red pixel P2 captured by image sensor 202 (as part of Bayer pattern 518) is inaccurate. A corrected pixel value (e.g., first corrected pixel value 632) at a down sampling pixel location 702 is obtained using a pixel value of a virtual pixel 706 at location obtained by offsetting down sampling pixel location 702 (if there is no horizontal shifting of a focal point due to chromatic aberrations) vertically by a distance 704 (e.g., a negative vertical pixel offset). Thus, the corrected pixel value is generated at down sampling pixel location 702 and output from vertical foveated down sampling and correction circuit 630 as first corrected pixel value 632. Similarly, for a positive vertical pixel offset, a corrected pixel value (e.g., first corrected pixel value 632) at a down sampling pixel location 712 is obtained using a pixel value of a virtual pixel 716 at location obtained by offsetting down sampling pixel location 712 vertically by a distance 714 (e.g., the positive vertical pixel offset). Thus, the corrected pixel value is generated at down sampling pixel location 712 and output from vertical foveated down sampling and correction circuit 630 as first corrected pixel value 632.

As will be further described below, first offset value 704 (or first offset value 714) is used as a parameter to obtain a phase value for a bilinear or bicubic interpolation (e.g., equal to a distance from location of virtual pixel 706 to red pixel P2, and similarly equal to a distance from location of virtual pixel 716 to red pixel P2). The phase value is used to obtain interpolation coefficients for the bilinear or bicubic interpolation of pixel values of neighboring red pixels P0, P1, P2, and P3 in the vertical direction to compute the pixel value of virtual pixel 706 (or virtual pixel 716). The computed pixel value of virtual pixel 706 (or the computed pixel value of virtual pixel 716) then becomes first corrected pixel value 632 output from vertical foveated down sampling and correction circuit 630 at down sampling pixel location 702 (or at down sampling pixel location 712). Such corrections of pixel values and pixel locations are performed for all red pixels to account for the vertical chromatic aberration and/or the vertical foveated down sampling. The blue color channel of pixels also have their vertical offset corrected in a similar manner as the red color channel of pixels shown in FIG. 7A.

FIG. 7B illustrates horizontal interpolation based on horizontal offset pixel correction for a red color channel of a subset of pixels, according to one embodiment. The red pixels in FIG. 7B have pixel values corrected using vertical offsets as explained above with reference to FIG. 7A. The pixel value of red pixel P6 corrected for the vertical chromatic aberration does not take into account the horizontal chromatic aberration. In order to account for the horizontal chromatic aberration, the pixel value of pixel P6 is replaced with a pixel value of a virtual pixel 726 (or a virtual pixel 736) that is horizontally offset from a location 722 of pixel P6 by a distance 724 (or a second offset value) for a negative horizontal pixel offset or by a distance 734 (or a second offset value) for a positive horizontal pixel offset. As will be further described below, second offset value 724 (or second offset value 734) is used as a parameter to interpolate pixel values of neighboring pixels P4, P5, P6, and P7 in the horizontal direction. Such replacement is performed across all red pixels to correct the horizontal chromatic aberration. The blue color channel of pixels also have their horizontal offset corrected in a similar manner as the red color channel of pixels shown in FIG. 7B.

FIG. 8 illustrates grid points GPO through GP3 that surrounds a given pixel 802, according to one embodiment. As described above, each of grid points GPO through GP3 has an associated vertical and horizontal offset values for red and blue pixels stored in offset LUT 612. If pixel 802 is a red pixel, offset interpolator circuit 616 performs a bilinear interpolation or bicubic interpolation on four vertical offset values of the four grid points GPO through GP3 for red pixels and generates an interpolated vertical offset value 618 for the red pixel. Offset interpolator circuit 616 also performs a bilinear interpolation or bicubic interpolation on four horizontal offset values of the four grid points GPO through GP3 for red pixels and generates an interpolated horizonal offset value 620 for the red pixel. If pixel 802 is a blue pixel, offset interpolator circuit 616 performs a bilinear interpolation or bicubic interpolation on four vertical offset values of the four grid points GPO through GP3 for blue pixels and generates an interpolated vertical offset value (or first offset value) 618 for blue red pixel, and performs a bilinear interpolation or bicubic interpolation on four horizontal offset values of the four grid points GPO through GP3 for blue pixels and generates an interpolated horizonal offset value (or second offset value) 620 for the blue pixel.

Referring back to FIG. 6, offset interpolator circuit 616 provides, based on down sampling pixel locations 610 and pre-calculated vertical offset values 614, first offset values 618 (e.g., vertical pixel offset values) for the red and blue color channels of each pixel in raw image 602 to vertical phase LUT 622. Offset interpolator circuit 616 further provides, based on pre-calculated horizontal offset values 614, second offset values 620 (e.g., horizontal pixel offset values) for the red and blue color channels to horizontal phase LUT 624. In one embodiment, vertical phase LUT 622 stores a table of interpolation coefficients (e.g., bicubic or bilinear interpolation coefficients) for multiple phases in the first (e.g., vertical) direction where each phase has a set of coefficients (e.g., interpolation coefficients C₀, C₁, C₂, and C₃). Similarly, horizontal phase LUT 624 stores a table of interpolation coefficients (e.g., bicubic or bilinear interpolation coefficients) for multiple phases in the second (e.g., horizontal) direction where each phase has a set of coefficients (e.g., interpolation coefficients C₄, C₅, C₆, and C₇). Each table of interpolation coefficients is pre-computed and is associated with the same wide-angle lens that is associated with offset LUT 612.

Vertical phase LUT 622 uses first offset values 618 (e.g., vertical pixel offsets) calculated for the red and blue color channels for each pixel to define the phase of bilinear or bicubic interpolation in the first (e.g., vertical) direction. Similarly, horizontal phase LUT 624 uses second offset values 620 (e.g., horizontal pixel offsets) calculated for the red and blue color channels for each pixel to define the phase of bilinear or bicubic interpolation in the second (e.g., horizontal) direction. The phase in each of the first (e.g., vertical) and second (e.g., horizontal) directions functions as an index to its respective set of coefficients in the respective vertical and horizontal phase LUT 622, 624.

Vertical phase LUT 622 identifies first interpolation coefficients 626 that are associated with first offset values 618 for a specific color channel and provides first interpolation coefficients 626 to vertical foveated down sampling and correction circuit 630. Similarly, horizontal phase LUT 624 identifies second interpolation coefficients 628 that are associated with second offset values 620 for the specific color channel and provides second interpolation coefficients 628 to horizontal correction circuit 634.

Vertical foveated down sampling and correction circuit 630 performs combined foveated down sampling and chromatic aberration recovery in the first (e.g., vertical) direction of raw image 602. Vertical foveated down sampling and correction circuit 630 calculates corrected pixel values 632 with chromatic aberrations corrected in the first direction relative to raw image 602. In one embodiment, vertical foveated down sampling and correction circuit 630 calculates vertically down sampled and corrected versions of the pixel values (Pᵥ) of a specific color using interpolation, i.e.,

Pᵥ=C₀P₀+C₁P₁+C₂P₂+C₃P₃, (1)

where P₀ through P₃ represent pixel values of four pixels in a same column of raw image 602 and closest to a virtual pixel corresponding to the pixel whose value is being corrected to account for vertical chromatic aberration and/or vertical foveated down sampling, and C₀ through C₃ are first interpolation coefficients 626.

To calculate vertically corrected pixel value 632 for a pixel of a specific color, vertical foveated down sampling and correction circuit 630 obtains first interpolation coefficients 626 from vertical phase LUT 622 that retrieves first interpolation coefficients 626 (e.g., the set of interpolation coefficients C₀, C₁, C₂, and C₃) corresponding to first offset value 618 from vertical phase LUT 622. First offset value 618 represents a first distance (e.g., distance 704) from each down sampling pixel location 610 (or down sampling pixel location 702) to a corresponding virtual pixel (e.g., virtual pixel 706) in the first direction. Using first offset values 618 and first interpolation coefficients 626, vertical foveated down sampling and correction circuit 630 calculates corrected pixel value 632 of the specific color channel for the pixel closest to the virtual pixel using equation (1). Corrected pixel value 632 replaces the original pixel value for the specific color channel at down sampling pixel location 610 in the first direction.

Horizontal correction circuit 634 calculates pixel values 636 of a specific color channel with chromatic aberration corrected in the second (e.g., horizontal) direction relative to raw image 602. In one embodiment, horizontal correction circuit 634 calculates horizontally correction versions of pixel values 636 (Pₕ) using interpolation, i.e.,

Ph=C₄P₄+C₅P₅+C₆P₆+C₇P₇, (2)

where P₄ through P₇ represent pixel values of four pixels in a same row and closest to a virtual pixel corresponding to the pixel whose value is being corrected to account for horizontal chromatic aberration, and C₄ through C₇ are second interpolation coefficients 628.

To calculate horizontally corrected pixel value 636 for a pixel of a specific color, horizontal correction circuit 634 obtains second interpolation coefficients 628 from horizontal phase LUT 624 that retrieves second interpolation coefficients 628 (e.g., the set of coefficients C₄, C₅, C₆, and C₇) corresponding to second offset value 620 from horizontal phase LUT 624. Second offset value 620 represents a second distance (e.g., distance 724) from a pixel location (e.g., location of pixel P₆) to a corresponding virtual pixel (e.g., virtual pixel 726) in the second direction. Using second offset values 620 and second interpolation coefficients 628, horizontal correction circuit 634 calculates corrected pixel value 636 of the specific color channel for the pixel closest to the virtual pixel using equation (2). Corrected pixel value 636 replaces corresponding vertically corrected pixel value 632 at a same pixel location of vertically corrected pixel value 632 as no down sampling is performed by horizontal correction circuit 634.

Corrected pixel values 636 for pixels from raw image 602 represent a second corrected raw image 636 vertically down sampled with mitigated chromatic aberrations in vertical and horizontal directions. Second corrected raw image 636 can be used by image signal processor 206 to generate a full-color image with reduced chromatic aberrations.

Horizontal foveated down sampling and scaler circuit 648 is coupled to an output of FDS-C circuit 307. Horizontal foveated down sampling and scaler circuit 648 receives pixel values of second corrected raw image 636 and performs horizontal foveated down sampling and scaling to the pixel values of second corrected raw image 636.

Down sampling scaling factor LUT 640 stores second down sampling scaling factors indexed by locations in the second direction (e.g., horizontal direction) of an image (e.g., corrected raw image 636). Down sampling scaling factor LUT 640 receives indexing information 638 related to a location of a corresponding pixel along the second direction in second corrected raw image 636. Indexing information 638 for the corresponding pixel along the second direction in second corrected raw image 636 is extracted by pixel locator circuit 637. Upon receiving indexing information 638, down sampling scaling factor LUT 640 outputs a corresponding second down sampling scaling factor 642 that is passed onto foveated down sampling locator circuit 644.

Foveated down sampling locator circuit 644 receives down sampling scaling factor 642 from down sampling scaling factor LUT 640, and calculates a down sampling pixel location 646 (e.g., down sampling landing) along the second direction of second corrected raw image 636. Information about down sampling pixel location 646 calculated by foveated down sampling locator circuit 644 is provided to horizontal foveated down sampling and scaler circuit 648.

Horizontal foveated down sampling and scaler circuit 648 performs down sampling of a subset of pixels of a same color of second corrected raw image 636 arranged in the second direction using second down sampling scaling factors 642 gradually varying along the second direction to generate corrected pixel values for pixels of the same color in corrected raw image 650. The corrected pixel values of corrected raw image 650 replace pixel values 636 of the specific color channel at down sampling pixel locations 646.

### Example Foveated Down Sampling Circuit

FIG. 9A is a block diagram illustrating a detailed view of a first example of FDS circuit 309, according to one embodiment. FDS circuit 309 may perform foveated down sampling of pixels in an image (e.g., a raw image generated by one or more image sensors 202, or an image in RGB format). Specifically, FDS circuit 309 in FIG. 9A may perform foveated down sampling in a vertical direction of input pixels 902 in the image to generate first down sampled pixels 922 in a first down sampled version of the image. FDS circuit 309 may further perform foveated down sampling in a horizontal direction of first down sampled pixels 922 to generate second down sampled pixels 942 of a second down sampled version of the image. FDS circuit 309 may include a vertical pixel locator circuit 904, a vertical scaling factor storage circuit 908, a vertical scaling factor calculator circuit 912, a vertical foveated down sampling locator circuit 916, a vertical foveated down sampling circuit 920 with a line buffer 903, a horizontal pixel locator circuit 924, a horizontal scaling factor storage circuit 928, a horizontal scaling factor calculator circuit 932, a horizontal foveated down sampling locator circuit 936, and a horizontal foveated down sampling circuit 940. FDS circuit 309 may include additional or fewer circuits than those shown in FIG. 9A.

Vertical pixel locator circuit 904 is a circuit that extracts index 906 for each pixel 902 with information about a respective location of each pixel 902 along the vertical direction (e.g., along a corresponding column) of the image. Vertical pixel locator circuit 904 may pass extracted index 906 to vertical scaling factor storage circuit 908. Vertical scaling factor storage circuit 908 may store scaling factors indexed by locations in the vertical direction of the image. Vertical scaling factor storage circuit 908 may be embodied as a LUT with a list of scaled factors indexed by locations in the vertical direction of the image. Vertical scaling factor storage circuit 908 may receive index 906 related to the respective location of each pixel 902 along the vertical direction in the image. Upon receiving index 906, vertical scaling factor storage circuit 908 may output a corresponding scaling factor 910 that is passed onto vertical scaling factor calculator circuit 912.

Scaling factors 910 stored in vertical scaling factor storage circuit 908 may be configured in accordance with configuration information 907. Configuration information 907 may configure (e.g., program) vertical scaling factor storage circuit 908 with a list of scaling factors 910 that vary along the vertical direction in accordance with, e.g., a piecewise fixed distribution, curvature continuous distribution, linear continuous distribution, some other distribution, or combination thereof. For the piecewise fixed distribution, the vertical direction (or equivalently the horizontal direction) may be divided into different regions (e.g., up to five different regions), and each region may be associated with a respective value of scaling factor 910. For the curvature continuous distribution, scaling factors 910 may vary continuously (e.g., along the vertical direction) at a non-linear rate of change (e.g., defined by a corresponding curvature function). For the linear continuous distribution, scaling factors 910 may vary continuously (e.g., along the vertical direction) at a linear rate of change (e.g., defined by a slope of a corresponding linear function). Configuration information 907 may configure rate changes and the number of rate changes (e.g., up to five rate changes across up to five different regions) in the vertical direction. In one or more embodiments, at least one region of a rate change for scaling factors 910 in the vertical direction corresponds to a zero rate change (e.g., region(s) with constant scaling factors 910 in the vertical direction). Configuration information 907 may be received, for example, from a software executed by CPU 208.

Vertical scaling factor calculator circuit 912 is a circuit that calculates each scaling factor 914 based on one or more scaling factors 910 received from vertical scaling factor storage circuit 908, e.g., based on a configuration mode signal 911. In one embodiment, configuration mode signal 911 configures vertical scaling factor calculator circuit 912 to calculate each scaling factor 914 to gradually vary along the vertical direction in accordance with, e.g., the piecewise fixed distribution, the curvature continuous distribution, the linear continuous distribution, some other distribution, or combination thereof. In another embodiment, configuration mode signal 911 configures vertical scaling factor calculator circuit 912 to calculate each scaling factor 914 to vary along the vertical direction at one or more rates of change along the vertical direction. For example, a first rate of change of scaling factors 914 produced by vertical scaling factor calculator circuit 912 may be negative starting at a beginning of a column (e.g., upper edge of the column) and ending at a first vicinity of a center of the column. A second rate of change of scaling factors 914 produced by vertical scaling factor calculator circuit 912 may be positive starting at a second vicinity of the center of the column and ending at an end of the column (e.g., lower edge of the column). In another embodiment, configuration mode signal 911 disables vertical scaling factor calculator circuit 912, and scaling factors 910 retrieved from vertical scaling factor storage circuit 908 may be passed onto vertical foveated down sampling locator circuit 916 as scaling factors 914.

Vertical foveated down sampling locator circuit 916 is a circuit that calculates a down sampling pixel location 918 (e.g., a down sampling landing) along the vertical direction (e.g., along a corresponding column of the image) as a function of a corresponding scaling factor 914. Information about down sampling pixel location 918 may be provided onto vertical foveated down sampling circuit 920.

Vertical foveated down sampling circuit 920 may include line buffer 903 that buffers a set of pixels 902 that belong to a defined number of horizontal lines (e.g., rows) in the image corresponding to scanning of the image (e.g., during capturing by one or more sensors 202). In one or more embodiments, line buffer 903 is a component separate from vertical foveated down sampling circuit 920. Vertical foveated down sampling circuit 920 may perform, in a streaming manner, down sampling of a first subset of pixels 902 (e.g., subset of pixels 902 stored in line buffer 903) of a same color arranged in the vertical direction (e.g., along a corresponding column of the image) using information about down sampling pixel location 918 (e.g., down sampling landings) to generate a corresponding first down sampled pixel 922 of the same color in a first down sampled version of the image. Vertical foveated down sampling circuit 920 may perform the down sampling by performing an interpolation (e.g., the bilinear interpolation, the bicubic interpolation, some other interpolation, or combination thereof) of pixel values in the first subset of pixels 902 of the same color to generate a pixel value of the same color for first down sampled pixel 922.

As the down sampling is performed in the streaming manner at vertical foveated down sampling circuit 920, only part of an image may be received as pixels 902 from, e.g., a buffer (not shown) or system memory 230. The vertical down sampling can start when a sufficient number of pixels 902 of the image for generating (e.g., via the interpolation) a first down sampled pixel 922 is received and available at vertical foveated down sampling circuit 920 (e.g., in line buffer 903). The vertical down sampling operation may continuously proceed at vertical foveated down sampling circuit 920 to generate first down sampled pixels 922 as further incoming pixels 902 are received without waiting for the entire image. Vertical foveated down sampling circuit 920 may perform down sampling in the vertical direction in a single pass (without using separate passes for different scaling factors) through columns of pixels 902 to reduce the time and resources associated with the down sampling operation. First down sampled pixels 922 generated by vertical foveated down sampling circuit 920 may represent a portion of the image down sampled along the vertical direction. First down sampled pixels 922 may be passed onto horizontal pixel locator circuit 924 and horizontal foveated down sampling circuit 940 for further down sampling along the horizontal direction.

Horizontal pixel locator circuit 924 is a circuit that extracts index 926 for each pixel 922 with information about a respective location of each pixel 922 along the horizontal direction (e.g., along a corresponding row) of the image. Horizontal pixel locator circuit 924 may pass extracted index 926 to horizontal scaling factor storage circuit 928. Horizontal scaling factor storage circuit 928 may store scaling factors indexed by locations in the horizontal direction of the image. Horizontal scaling factor storage circuit 928 may be embodied as a LUT with a list of scaled factors indexed by locations in the horizontal direction of the image. Horizontal scaling factor storage circuit 928 may receive index 926 related to the respective location of each pixel 922 along the horizontal direction in the image. Upon receiving index 926, horizontal scaling factor storage circuit 928 may output a corresponding scaling factor 930 that is passed onto horizontal scaling factor calculator circuit 912. Scaling factors stored in horizontal scaling factor storage circuit 928 may be configured in accordance with configuration information 927. Configuration information 927 may configure (e.g., program) horizontal scaling factor storage circuit 928 with a list of scaling factors 930 that vary along the horizontal direction in accordance with, e.g., the piecewise fixed distribution, the curvature continuous distribution, the linear continuous distribution, some other distribution, or combination thereof. Configuration information 927 may configure rate changes and the number of rate changes (e.g., up to five rate changes across up to five different regions) in the horizontal direction. In one or more embodiments, at least one region of a rate change for scaling factors 930 in the horizontal direction corresponds to a zero rate change (e.g., region(s) with constant scaling factors 930 in the horizontal direction). Configuration information 927 may be received, for example, from a software executed by CPU 208.

Horizontal scaling factor calculator circuit 932 is a circuit that calculates each scaling factor 934 based on one or more scaling factors 930 received from horizontal scaling factor storage circuit 928, e.g., based on a configuration mode signal 931. In one embodiment, configuration mode signal 931 configures horizontal scaling factor calculator circuit 932 to calculate each scaling factor 934 to gradually vary along the horizontal direction in accordance with, e.g., the piecewise fixed distribution, the curvature continuous distribution, the linear continuous distribution, some other distribution, or combination thereof. In another embodiment, configuration mode signal 931 configures horizontal scaling factor calculator circuit 932 to calculate each scaling factor 934 to vary along the horizontal direction at one or more rates of change along the horizontal direction. For example, a first rate of change of scaling factors 934 produced by horizontal scaling factor calculator circuit 932 may be negative starting at a beginning of a row (e.g., left edge of the row) and ending at a first vicinity of a center of the row. A second rate of change of scaling factors 934 produced by horizontal scaling factor calculator circuit 932 may be positive starting at a second vicinity of the center of the row and ending at an end of the row (e.g., right edge of the row). In another embodiment, configuration mode signal 931 disables horizontal scaling factor calculator circuit 932, and scaling factors 930 retrieved from horizontal scaling factor storage circuit 928 may be passed onto horizontal foveated down sampling locator circuit 936 as scaling factors 934.

Horizontal foveated down sampling locator circuit 936 is a circuit that calculates a down sampling pixel location 938 (e.g., a down sampling landing) along the horizontal direction (e.g., along a corresponding row of the image) as a function of a corresponding scaling factor 934. Information about down sampling pixel location 938 may be provided onto horizontal foveated down sampling circuit 940.

Horizontal foveated down sampling circuit 940 may receive a second subset of first down sampled pixels 922 arranged in the horizontal direction (e.g., along a corresponding row of the image). Horizontal foveated down sampling circuit 940 may perform down sampling of the second subset of pixels 922 of the same color in the streaming manner using information about down sampling pixel location 938 (e.g., down sampling landing) to generate a corresponding second down sampled pixel 942 of the same color in a second down sampled version of the image. Horizontal foveated down sampling circuit 940 may perform the down sampling by performing an interpolation (e.g., the bilinear interpolation, the bicubic interpolation, some other interpolation, or combination thereof) of pixel values in the second subset of pixels 922 of the same color to generate a pixel value of the same color for second down sampled pixel 942.

Horizontal foveated down sampling circuit 940 may start performing horizontal down sampling (e.g., via the interpolation) after a sufficient number of pixels 922 for generating a second down sampled pixel 942 is received and available at horizontal foveated down sampling circuit 940. The down sampling in the horizontal direction is performed at horizontal foveated down sampling circuit 940 to continuously generate subsequent down sampled pixels 942 as further pixels 922 are received from vertical foveated down sampling circuit 920. The down sampling in the horizontal direction at horizontal foveated down sampling circuit 940 is also performed in a single pass through rows of pixels 922 without separate passes for different scaling factors to reduce the time and resources associated with the down sampling operation. Second down sampled pixels 942 generated by horizontal foveated down sampling circuit 940 may represent a portion of second down sampled version of the image after performing the foveated down sampling in the vertical direction followed by the foveated down sampling in the horizontal direction.

FIG. 9B is a block diagram illustrating a detailed view of a second example of FDS circuit 309, according to one embodiment. FDS circuit 309 may perform foveated down sampling of pixels in an image (e.g., raw image generated by one or more image sensors 202, or an image in RGB format). Specifically, FDS circuit 309 in FIG. 9B may perform foveated down sampling in a horizontal direction of input pixels 952 in the image to generate first down sampled pixels 972 in a first down sampled version of the image. FDS circuit 309 may further perform foveated down sampling in a vertical direction of first down sampled pixels 972 to generate second down sampled pixels 992 of a second down sampled version of the image. FDS circuit 309 may include a horizontal pixel locator circuit 954, a horizontal scaling factor storage circuit 958, a horizontal scaling factor calculator circuit 962, a horizontal foveated down sampling locator circuit 966, a horizontal foveated down sampling circuit 970, a vertical pixel locator circuit 974, a vertical scaling factor storage circuit 978, a vertical scaling factor calculator circuit 982, a vertical foveated down sampling locator circuit 986, and a vertical foveated down sampling circuit 990 with a line buffer 953. FDS circuit 309 may include additional or fewer circuits than those shown in FIG. 9B.

Horizonal pixel locator circuit 954 is a circuit that extracts index 956 for each pixel 952 with information about a respective location of each pixel 952 along the horizonal direction (e.g., along a corresponding row) of the image. Horizonal pixel locator circuit 954 may pass extracted index 956 to horizonal scaling factor storage circuit 958. Horizonal scaling factor storage circuit 958 may store scaling factors indexed by locations in the horizonal direction of the image. Horizonal scaling factor storage circuit 958 may be embodied as a LUT with a list of scaled factors indexed by locations in the horizonal direction of the image. Horizonal scaling factor storage circuit 958 may receive index 956 related to the respective location of each pixel 952 along the horizonal direction in the image. Upon receiving index 956, horizonal scaling factor storage circuit 958 may output a corresponding scaling factor 960 that is passed onto horizonal scaling factor calculator circuit 962. Scaling factors 960 stored in horizonal scaling factor storage circuit 958 may be configured in accordance with configuration information 957. Configuration information 957 may configure (e.g., program) horizonal scaling factor storage circuit 958 with a list of scaling factors 960 that vary along the horizonal direction in accordance with, e.g., the piecewise fixed distribution, the curvature continuous distribution, the linear continuous distribution, some other distribution, or combination thereof. Configuration information 957 may configure rate changes and the number of rate changes (e.g., up to five rate changes across up to five different regions) in the horizontal direction. In one or more embodiments, at least one region of a rate change for scaling factors 960 in the horizontal direction corresponds to a zero rate change (e.g., region(s) with constant scaling factors 960 in the horizontal direction). Configuration information 957 may be received, for example, from a software executed by CPU 208.

Horizonal scaling factor calculator circuit 962 is a circuit that calculates each scaling factor 964 based on one or more scaling factors 960 received from horizonal scaling factor storage circuit 958, e.g., based on a configuration mode signal 961. In one embodiment, configuration mode signal 961 configures horizonal scaling factor calculator circuit 962 to calculate each scaling factor 964 to gradually vary along the horizonal direction in accordance with, e.g., the piecewise fixed distribution, the curvature continuous distribution, the linear continuous distribution, some other distribution, or combination thereof. In another embodiment, configuration mode signal 961 configures horizonal scaling factor calculator circuit 962 to calculate each scaling factor 964 to vary along the horizonal direction at one or more rates of change along the horizonal direction. For example, a first rate of change of scaling factors 964 produced by horizonal scaling factor calculator circuit 962 may be negative starting at a beginning of a row (e.g., left edge of the row) and ending at a first vicinity of a center of the row. A second rate of change of scaling factors 964 produced by horizonal scaling factor calculator circuit 962 may be positive starting at a second vicinity of the center of the row and ending at an end of the row (e.g., right edge of the row). In another embodiment, configuration mode signal 961 disables horizonal scaling factor calculator circuit 962, and scaling factors 960 retrieved from horizonal scaling factor storage circuit 958 may be passed onto horizonal foveated down sampling locator circuit 966 as scaling factors 964.

Horizontal foveated down sampling locator circuit 966 is a circuit that calculates a down sampling pixel location 968 (e.g., a down sampling landing) along the horizonal direction (e.g., along a corresponding row of the image) as a function of a corresponding scaling factor 964. Information about down sampling pixel location 968 may be provided onto horizontal foveated down sampling circuit 920.

Horizontal foveated down sampling circuit 970 may perform, in a streaming manner, down sampling of a first subset of pixels 952 of a same color arranged in the horizontal direction (e.g., along a corresponding row of the image) using information about down sampling pixel location 968 (e.g., down sampling landing) to generate a corresponding first down sampled pixel 972 of the same color in a first down sampled version of the image. Horizontal foveated down sampling circuit 970 may perform the down sampling by performing an interpolation (e.g., the bilinear interpolation, the bicubic interpolation, some other interpolation, or combination thereof) of pixel values in the first subset of pixels 952 of the same color to generate a pixel value of the same color for first down sampled pixel 972.

As the horizontal down sampling is performed in the streaming manner at horizontal foveated down sampling circuit 970, only part of an entire image may be received and stored as pixels 952 in, e.g., a buffer (not shown in FIG. 9B) or system memory 230. That is, the horizontal down sampling may start when the first subset of pixels 952 sufficient to perform horizontal down sampling (e.g., via the interpolation) is received and available at horizontal foveated down sampling circuit 970, and the down sampling can continuously proceed at horizontal foveated down sampling circuit 970 for incoming pixels 952 to generate first down sampled pixels 972. Horizontal foveated down sampling circuit 970 may perform down sampling in the horizontal direction in a single pass through rows of pixels 952. First down sampled pixels 972 generated by horizontal foveated down sampling circuit 970 may represent a portion of the image down sampled along the horizontal direction. First down sampled pixels 972 may be passed onto vertical pixel locator circuit 974 and vertical foveated down sampling circuit 980 for further down sampling along the vertical direction of the image.

Vertical pixel locator circuit 974 is a circuit that extracts index 976 for each pixel 972 with information about a respective location of each pixel 972 along the vertical direction (e.g., along a corresponding column) of the image. Vertical pixel locator circuit 974 may pass extracted index 976 to vertical scaling factor storage circuit 978. Vertical scaling factor storage circuit 978 may store scaling factors indexed by locations in the vertical direction of the image. Vertical scaling factor storage circuit 978 may be embodied as a LUT with a list of scaled factors indexed by locations in the vertical direction of the image. Vertical scaling factor storage circuit 978 may receive index 906 related to the respective location of each pixel 972 along the vertical direction in the image. Upon receiving index 976, vertical scaling factor storage circuit 978 may output a corresponding scaling factor 980 that is passed onto vertical scaling factor calculator circuit 982. Scaling factors 980 stored in vertical scaling factor storage circuit 978 may be configured in accordance with configuration information 977. Configuration information 977 may configure (e.g., program) vertical scaling factor storage circuit 978 with a list of scaling factors 980 that vary along the vertical direction in accordance with, e.g., the piecewise fixed distribution, the curvature continuous distribution, the linear continuous distribution, some other distribution, or combination thereof. Configuration information 977 may configure rate changes and the number of rate changes (e.g., up to five rate changes across up to five different regions) in the vertical direction. In one or more embodiments, at least one region of a rate change for scaling factors 980 in the vertical direction corresponds to a zero rate change (e.g., region(s) with constant scaling factors 980 in the vertical direction). Configuration information 977 may be received, for example, from a software executed by CPU 208.

Vertical scaling factor calculator circuit 982 is a circuit that calculates each scaling factor 984 based on one or more scaling factors 980 received from vertical scaling factor storage circuit 978, e.g., based on a configuration mode signal 981. In one embodiment, configuration mode signal 981 configures vertical scaling factor calculator circuit 982 to calculate each scaling factor 984 to gradually vary along the vertical direction in accordance with, e.g., the piecewise fixed distribution, the curvature continuous distribution, the linear continuous distribution, some other distribution, or combination thereof. In another embodiment, configuration mode signal 981 configures vertical scaling factor calculator circuit 982 to calculate each scaling factor 984 to vary along the vertical direction at one or more rates of change along the vertical direction. For example, a first rate of change of scaling factors 984 produced by vertical scaling factor calculator circuit 982 may be negative starting at a beginning of a column (e.g., upper edge of the column) and ending at a first vicinity of a center of the column. A second rate of change of scaling factors 984 produced by vertical scaling factor calculator circuit 982 may be positive starting at a second vicinity of the center of the column and ending at an end of the column (e.g., lower edge of the column). In another embodiment, configuration mode signal 981 disables vertical scaling factor calculator circuit 982, and scaling factors 980 retrieved from vertical scaling factor storage circuit 978 may be passed onto vertical foveated down sampling locator circuit 986 as scaling factors 984.

Vertical foveated down sampling locator circuit 986 is a circuit that calculates a down sampling pixel location 978 (e.g., a down sampling landing) along the vertical direction (e.g., along a corresponding column of the image) as a function of a corresponding scaling factor 984. Information about down sampling pixel location 988 may be provided onto vertical foveated down sampling circuit 990.

Vertical foveated down sampling circuit 990 may include line buffer 953 that buffers a set of pixels 972 that belong to a defined number of horizontal lines (e.g., rows) in the first down sampled version of the image corresponding to scanning of the image (e.g., during capturing by one or more sensors 202). In one or more embodiments, line buffer 953 is a component separate from vertical foveated down sampling circuit 990. Vertical foveated down sampling circuit 990 may perform down sampling of a second subset of pixels 972 (e.g., subset of pixels 972 stored in line buffer 953) of the same color arranged in the vertical direction (e.g., along a corresponding column of the image) in the streaming manner using information about down sampling pixel locations 988 to generate second down sampled pixels 992 of the same color in a second down sampled version of the image. Vertical foveated down sampling circuit 990 may perform the down sampling by performing an interpolation (e.g., the bilinear interpolation, the bicubic interpolation, some other interpolation, or combination thereof) of pixel values in the second subset of pixels 972 of the same color to generate a pixel value of the same color for second down sampled pixel 992.

Vertical foveated down sampling circuit 990 may start vertical down sampling operation when a sufficient number of pixels 972 for performing interpolation in a vertical direction is received and stored in line buffer 953. Vertical foveated down sampling circuit 990 may continue to receive pixels 972 and perform down sampling in the vertical direction in a single pass through columns of pixels 972 to generate further second down sampled pixels 992. Second down sampled pixels 992 generated by vertical foveated down sampling circuit 990 may represent a portion of the second down sampled version of the image after performing the foveated down sampling in the horizonal direction followed by the foveated down sampling in the vertical direction.

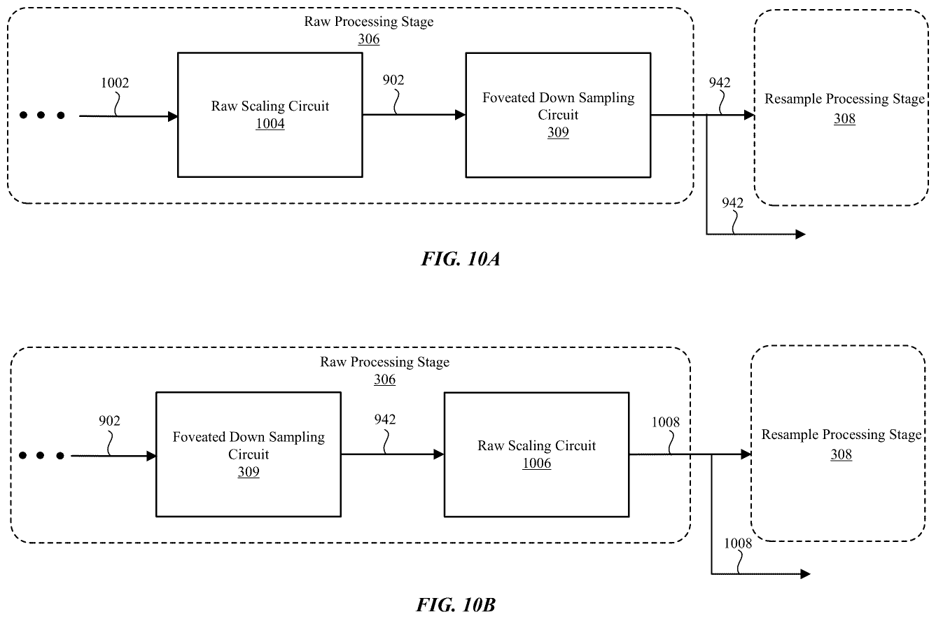

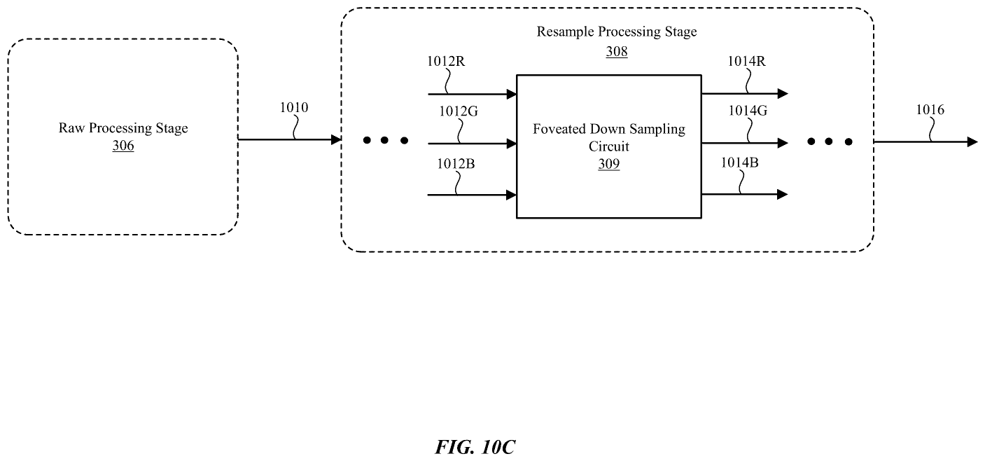

FIG. 10A is an example block diagram of raw processing stage 306 with FDS circuit 309, according to one embodiment. Raw processing stage 306 in FIG. 10A includes, among other components, a raw scaling circuit 1004 followed by FDS circuit 309. Pixels 1002 of a version of raw image (e.g., image obtained by one or more image sensors 202) may be generated by other components of raw processing stage 306 (not shown in FIG. 10A) and provided onto raw scaling circuit 1004. Raw scaling circuit 1004 may perform scaling of pixel values 1002 of each color component in the version of raw image (e.g., to adjust gain for each color component) to generate pixels 902 with scaled pixel values provided onto FDS circuit 309. In some embodiments, raw scaling circuit 1004 is bypassed. As discussed in detail in relation to FIG. 9A, FDS circuit 309 may generate down sampled pixels 942 for each color component in a down sampled version of raw image. Down sampled pixels 942 may be provided onto resample processing stage 308 for performing, e.g., color correction, resampling, and/or scaling of down sampled pixels 942. Alternatively, down sampled pixels 942 may be provided to, e.g., system memory 230 or persistent storage 228 for later processing.

FIG. 10B is another example block diagram of raw processing stage 306 with FDS circuit 309, according to one embodiment. Raw processing stage 306 in FIG. 10A includes, among other components, FDS circuit 309 followed by a raw scaling circuit 1006. Pixels 902 of a version of raw image (e.g., image obtained by one or more image sensors 202) may be generated by other components of raw processing stage 306 (not shown in FIG. 10B) and provided onto FDS circuit 309. As discussed in detail in relation to FIG. 9A, FDS circuit 309 may generate down sampled pixels 942 for each color component in a down sampled version of raw image. Down sampled pixels 942 may be provided onto raw scaling circuit 1006. Raw scaling circuit 1006 may perform scaling of pixel values of each color component of down sampled pixels 942 (e.g., to adjust gain for each color component) to generate scaled down sampled pixels 1008. Raw scaling circuit 1006 may perform substantially the same processing operations as raw scaling circuit 1004. In some embodiments, raw scaling circuit 1006 is bypassed. Scaled down sampled pixels 1008 may be provided onto resample processing stage 308 for performing, e.g., color correction, resampling, and/or scaling of scaled down sampled pixels 1008. Alternatively, scaled down sampled pixels 1008 may be provided to, e.g., system memory 230 or persistent storage 228 for later processing.

FIG. 10C is a block diagram of resample processing stage 308 with FDS circuit 309, according to one embodiment. Raw processing stage 306 may generate processed raw image data 1010 provided onto resample processing stage 308. One or more components of resample processing stage 308 may convert processed raw image data 1010 into image data of a color format, e.g., image data 1012R, 1012G, 1012B in RGB format provided onto FDS circuit 309. FDS circuit 309 may operate in the substantially same manner as described in relation to FIGS. 9A and 9B, and FDS circuit 309 may apply foveated down sampling on different color channels of pixels in image data 1012R, 1012G, 1012B. FDS circuit 309 may generate corresponding down sampled version of image data 1014R, 1014G, 1014B in the color format (e.g., RGB format) that may be provided to one or more other components of resample processing stage 308. Resample processing stage 308 may output resampled image data 1016 that may be passed onto, e.g., noise processing stage 310. Alternatively, resampled image data 1016 may be provided to, e.g., system memory 230 or persistent storage 228 for later processing.

### Example Process of Foveated Down Sampling and Correction Circuit

FIG. 11 is a flowchart illustrating a method of performing foveated down sampling and correction by an image processor (e.g., ISP 206) to reduce color fringing of raw image data, according to one embodiment. The image processor performs 1102 (e.g., by vertical foveated down sampling and correction circuit 630) combined vertical foveated down sampling and interpolation of pixel values of a first subset of pixels of a same color in a raw image (e.g., pixels of raw image 602) using down sampling scaling factors (e.g., first down sampling scaling factors 606) and first interpolation coefficients (e.g., first interpolation coefficients 626) to generate first corrected pixel values (e.g., corrected pixel values 632) for pixels of the same color in a first corrected version of the raw image. The pixels in the first subset are arranged in a first direction (e.g., vertical direction), the down sampling scaling factors gradually vary along the first direction, and the first interpolation coefficients correspond to first offset values (e.g., first offset values 618).

The first offset values represent first distances (e.g., distances 704, 714) from each down sampling pixel location (e.g., each down sampling pixel location 610, 702, 712) along the first direction to corresponding first virtual pixels (e.g., virtual pixels 706, 716) in the first direction. The image processor generates (e.g., by vertical foveated down sampling and correction circuit 630) one of the first corrected pixel values for a pixel in the first corrected version by down sampling and interpolating a number of pixels in the same column of the raw image using a corresponding one of the down sampling scaling factors and a corresponding subset of the first interpolation coefficients.

The image processor receives 1104 (e.g., by horizontal correction circuit 634) the first corrected pixel values (e.g., corrected pixel values 632) of the first corrected version. The image processor performs 1106 (e.g., by horizontal correction circuit 634) interpolation of pixel values of a second subset of the pixels in the first corrected version using second interpolation coefficients (e.g., second interpolation coefficients 628) to generate second corrected pixel values (e.g., corrected pixel values 636) for pixels of the same color in a second corrected version of the raw image. The pixels in the second subset are arranged in a second direction (e.g., horizontal direction) perpendicular to the first direction, and the second interpolation coefficients correspond to second offset values (e.g., second offset values 620).

The second offset values represent second distances (e.g., distances 724, 734) from the second subset of pixels to corresponding second virtual pixels (e.g., virtual pixels 726, 736) in the second direction. The image processor generates (e.g., by horizontal correction circuit 634) one of the second corrected pixel values for a pixel in the second corrected version by interpolating a number of pixels in the same row of the first corrected version using a corresponding subset of the second interpolation coefficients.

The first subset of pixels are in a same column of the raw image having the Bayer pattern, and the second subset of pixels are in a same row of the first corrected version of the raw image having the Bayer pattern. A value of each down sampling scaling factor depends on locations of a number of pixels in the same column of the raw image along the first direction, the number of pixels used for down sampling and interpolation to generate a corresponding corrected pixel value for a pixel in the first corrected version. In some embodiments, the down sampling scaling factors are gradually varying along the first direction based on, e.g., the piecewise fixed distribution, the curvature continuous distribution, the linear continuous distribution, some other distribution, or combination thereof. In one or more embodiments, one or more portions of the down sampling scaling factors are gradually scaled down at each defined down sampling pixel location in the first direction, and one or more other portions of the down sampling scaling factors are gradually scaled up at each defined down sampling pixel location in the first direction.

The image processor may further perform (e.g., by horizontal foveated down sampling and scaler circuit 648) horizontal foveated down sampling and scaling of the second corrected pixel values (e.g., corrected pixel values 636) for pixels of the same color in the second corrected version. The image processor may perform down sampling of a subset of the pixels of the same color of the second corrected version using second down sampling scaling factors (e.g., second down sampling scaling factors 642) to generate corrected pixel values for pixels of the same color in a corrected version of the raw image (e.g., corrected raw image 650). The pixels in the subset are arranged in the second (e.g., horizontal) direction, and the second down sampling scaling factors gradually vary along the second direction.

Embodiments of the process as described above with reference to FIG. 11 are merely illustrative. Moreover, sequence of the process may be modified or omitted.

### Example Process of Foveated Down Sampling Circuit

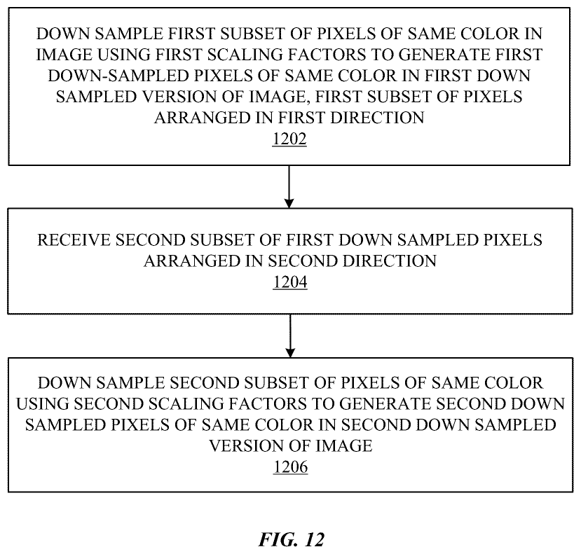

FIG. 12 is a flowchart illustrating a method of performing foveated down sampling by an image processor (e.g., ISP 206), according to one embodiment. The image processor down samples 1202 (e.g., by vertical foveated down sampling circuit 920 or horizontal foveated down sampling circuit 970 in FDS circuit 309) a first subset of pixels of a same color (e.g., pixels 902 or pixels 952) in an image using first scaling factors to generate first down sampled pixels of the same color (e.g., pixels 922 or pixels 972) in a first down sampled version of the image, the first subset of pixels arranged in a first direction (e.g., vertical direction or horizontal direction). The image processor may down sample the first subset of pixels in a single pass along the first direction. The image processor may determine (e.g., via vertical foveated down sampling locator circuit 916 or horizontal foveated down sampling locator circuit 966 in FDS circuit 309) each down sampling pixel location in the first direction based on a corresponding one of the first scaling factors.

The first subset of pixels may be in a same column of the image in a raw format or a color format (e.g., RGB format). Alternatively, the first subset of pixels may be in a same row of the image. The first scaling factors may gradually vary along the first direction in accordance with, e.g., the piecewise fixed distribution, the curvature continuous distribution or the linear continuous distribution. In some embodiments, a first set of the first scaling factors are gradually scaled down at each defined down sampling pixel location in the first direction, and a second set of the first scaling factors are gradually scaled up at each defined down sampling pixel location in the first direction. Alternatively, a first set of the first scaling factors may be scaled down with one or more first rate changes (e.g., one or more negative rate changes) in the first direction, and a second set of the first scaling factors may be scaled up with one or more second rate changes (e.g., one or more positive rate changes) in the first direction. The second set of first scaling factors may be distinct from the first set of first scaling factors, and the second set may include one or more first scaling factors of the first set. The first scaling factors may be changed (e.g., scaled up and scaled down) in the first direction according to, e.g., up to five rate changes. The number of rate changes in the first direction may be configurable.

The image processor receives 1204 a second subset of the first down sampled pixels (e.g., pixels 922 or pixels 972) arranged in a second direction (e.g., horizontal direction or vertical direction). The image processor down samples 1206 (e.g., by horizontal foveated down sampling circuit 940 or vertical foveated down sampling circuit 990) the second subset of pixels of the same color using second scaling factors to generate second down sampled pixels of the same color (e.g., pixels 942, or pixels 992) in a second down sampled version of the image. The image processor may perform down sampling of the second subset of pixels in a single pass along the second direction. The image processor may determine (e.g., via horizontal foveated down sampling locator circuit 936 or vertical foveated down sampling locator circuit 986) each down sampling pixel location in the second direction based on a corresponding one of the second scaling factors.

The second subset of pixels may be in a same row of the first down sampled version of the image in, e.g., the raw format or the color format. Alternatively, the second subset of pixels may be in a same column of the first down sampled version of the image. The second scaling factors may gradually vary along the first direction in accordance with, e.g., the piecewise fixed distribution, the curvature continuous distribution or the linear continuous distribution. In some embodiments, a first set of the second scaling factors are gradually scaled down at each defined down sampling pixel location in the second direction, and a second set of the second scaling factors are gradually scaled up at each defined down sampling pixel location in the second direction. Alternatively, a first set of the second scaling factors may be scaled down with one or more third rate changes (e.g., one or more negative rate changes) in the second direction, and a second set of the second scaling factors may be scaled up with one or more fourth rate changes (e.g., one or more positive rate change) in the second direction. The second set of second scaling factors may be distinct from the first set of second scaling factors, and the second set may include one or more second scaling factors of the first set. The second scaling factors may be changed (e.g., scaled up and scaled down) in the second direction according to, e.g., up to five rate changes. The number of rate changes in the second direction may be configurable.

Embodiments of the process as described above with reference to FIG. 12 are merely illustrative. Moreover, sequence of the process may be modified or omitted.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. An image processor comprising:
a first down sampling circuit configured to down sample a first subset of pixels of a same color in an image using first scaling factors to generate first down sampled pixels of the same color in a first down sampled version of the image, the first subset of pixels arranged in a first direction; and
a second down sampling circuit coupled to the first down sampling circuit, the second down sampling circuit configured to:
receive a second subset of the first down sampled pixels arranged in a second direction, and
down sample the second subset of pixels of the same color using second scaling factors to generate second down sampled pixels of the same color in a second down sampled version of the image.

2. The image processor of claim 1, wherein:
the first down sampling circuit is further configured to down sample the first subset of pixels in a single pass along the first direction; and
the second down sampling circuit is further configured to down sample the second subset of pixels in a single pass along the second direction.

3. The image processor of claim 1, wherein the first scaling factors gradually vary along the first direction, and the second scaling factors gradually vary along the second direction.

4. The image processor of claim 1, wherein the first direction is a vertical direction, and the second direction is a horizontal direction.

5. The image processor of claim 1, wherein the first subset of pixels are in a same column of the image in a raw format or a color format, and the second subset of pixels are in a same row of the first down sampled version of the image.

6. The image processor of claim 1, wherein the first subset of pixels are in a same row of the image in a raw format or a color format, and the second subset of pixels are in a same column of the first down sampled version of the image.

7. The image processor of claim 1, wherein at least one of the first scaling factors and the second scaling factors gradually vary along at least one of the first direction and the second direction based on a piecewise fixed distribution, curvature continuous distribution or linear continuous distribution.

8. The image processor of claim 1, wherein:
a first set of the first scaling factors are gradually scaled down at each defined down sampling pixel location in the first direction;
a second set of the first scaling factors are gradually scaled up at each defined down sampling pixel location in the first direction;
a first set of the second scaling factors are gradually scaled down at each defined down sampling pixel location in the second direction; and
a second set of the second scaling factors are gradually scaled up at each defined down sampling pixel location in the second direction.

9. The image processor of claim 1, wherein:
a first set of the first scaling factors are scaled down with one or more first rate changes in the first direction; and
a second set of the first scaling factors are scaled up with one or more second rate changes in the first direction;
a first set of the second scaling factors are scaled down with one or more third rate changes in the second direction; and
a second set of the second scaling factors are scaled up with one or more fourth rate changes in the second direction.

10. The image processor of claim 9, wherein at least one of the one or more first rate changes is negative, at least one of the one or more second rate changes is positive, at least one of the one or more third rate changes is negative, and at least one of the one or more fourth rate changes is positive.

11. The image processor of claim 1, further comprising:
a first down sampling locator circuit coupled to the first down sampling circuit, the first down sampling locator circuit configured to determine each down sampling pixel location in the first direction based on a corresponding one of the first scaling factors; and
a second down sampling locator circuit coupled to the second down sampling circuit, the second down sampling locator circuit configured to determine each down sampling pixel location in the second direction based on a corresponding one of the second scaling factors.

12. A method comprising:
down sampling a first subset of pixels of a same color in an image using first scaling factors to generate first down sampled pixels of the same color in a first down sampled version of the image, the first subset of pixels arranged in a first direction; and
down sampling a second subset of the first down sampled pixels of the same color using second scaling factors to generate second down sampled pixels of the same color in a second down sampled version of the image, the second subset of pixels arranged in a second direction.

13. The method of claim 12, further comprising:
down sampling the first subset of pixels in a single pass along the first direction; and
down sampling the second subset of pixels in a single pass along the second direction.

14. The method of claim 12, wherein the first subset of pixels are in a same column of the image in a raw format or a color format, and the second subset of pixels are in a same row of the first down sampled version of the image.

15. The method of claim 12, wherein:
a first set of the first scaling factors are gradually scaled down at each defined down sampling pixel location in the first direction; and
a second set of the first scaling factors are gradually scaled up at each defined down sampling pixel location in the first direction.

16. The method of claim 12, wherein:
a first set of the first scaling factors are scaled down with a negative rate change in the first direction; and
a second set of the first scaling factors are scaled up with a positive rate change in the first direction.

17. The method of claim 12, further comprising:
determining each down sampling pixel location in the first direction based on a corresponding one of the first scaling factors; and
determining each down sampling pixel location in the second direction based on a corresponding one of the second scaling factors.

18. A system, comprising:
at least one image sensor configured to capture an image; and
an image processor coupled to the at least one image sensor, the image processor comprising:
a first down sampling circuit configured to down sample a first subset of pixels of a same color in the image using first scaling factors to generate first down sampled pixels of the same color in a first down sampled version of the image, the first subset of pixels arranged in a first direction, and
a second down sampling circuit coupled to the first down sampling circuit, the second down sampling circuit configured to:
receive a second subset of the first down sampled pixels of the first down sampled version, the second subset of the first down sampled pixels arranged in a second direction, and
down sample the second subset of pixels of the same color using second scaling factors to generate second down sampled pixels of the same color in a second down sampled version of the image.

19. The system of claim 18, wherein:
the first down sampling circuit is further configured to down sample the first subset of pixels in a single pass along the first direction; and
the second down sampling circuit is further configured to down sample the second subset of pixels in a single pass along the second direction.

20. The system of claim 18, wherein:
a first set of the first scaling factors are gradually scaled down at each defined down sampling pixel location in the first direction; and
a second set of the first scaling factors are gradually scaled up at each defined down sampling pixel location in the first direction.
